(19) United States
(12) Patent Application Publication
(10) Pub. No.: US 2021/0316165 A1
(43) Pub. Date: Oct. 14, 2021

(54) FACE MASK

(71) Applicant: THE TRUSTEES OF INDIANA UNIVERSITY, Indianapolis, IN (US)

(72) Inventor: Jiangmei WU, Bloomington, IN (US)

(21) Appl. No.: 17/226,504

(22) Filed: Apr. 9, 2021

Related U.S. Application Data
(60) Provisional application No. 63/007,946, filed on Apr. 9, 2020.
(60) Provisional application No. 63/025,381, filed on May 15, 2020.

(51) Int. Cl. A62B 18/02; A41D 13/11; A41D 31/10; B01D 39/16; A62B 18/08; A62B 23/02; A62B 7/10

(52) U.S. Cl. CPC A62B 18/025; A41D 13/1161; A41D 31/10; A41D 13/1107; B01D 2239/0613; A62B 18/084; A62B 23/025; A62B 7/10; B01D 2239/0618; B01D 39/16

(57) ABSTRACT

A face mask adapted for covering a face of a user, including the nose, mouth, and chin. The face mask is configured to block airborne particles from passing between the surrounding atmosphere and the user.

### CROSS REFERENCE TO RELATED APPLICATIONS

This application claims priority to and the benefit of U.S. Provisional Patent Application No. 63/007,946, filed 9 Apr. 2020 and U.S. Provisional Patent Application No. 63/025,381, filed 15 May 2020, the disclosure of which are now expressly incorporated herein by reference.

### BACKGROUND

Medical professionals and healthcare workers wear surgical masks that are designed to prevent contaminants from passing from the medical professional to a patient. In an event of a virus pandemic, medical professionals and healthcare workers along with the general public may be required to wear medial respirators, such as N95 respirators, to prevent contamination and infection by airborne pathogens since common surgical masks do not provide a good fit to properly block and filter out the airborne pathogens.

However, medical respirators can be expensive and uncomfortable if worn for several hours. Further, supply of medical respirators is scarce in the event of a virus pandemic like that of the COVID-19 virus. As such, other face mask designs may be need to provide a good fit so as to efficiently filter out airborne particles and inexpensive to be adequately available to the general public.

### SUMMARY

A face mask adapted for covering a nose and mouth of a user is disclosed in this application. The face mask covers the nose and mouth of the uses to form a barrier between the nose and mouth of the user and the surrounding atmosphere.

The facemask includes a mask body and at least one attachment band. The mask body is formed from a mask blank made of a single two-dimensional sheet of material and configured to change between an unfolded arrangement in which that mask blank is a flat two-dimensional shape, a folded arrangement in which the mask blank is formed into a three-dimensional shape using origami techniques, and a flat-folded arrangement in which the mask blank remains folded and is collapsed to be substantially flat.

The at least one attachment band is coupled to the mask body and configured to extend between mask body and the user. The attachment band is configured to secure the mask body in the folded arrangement on the face of the user so that the perimeter edge contacts the face of the user when the user is using the face mask.

The mask blank is made of a single sheet of material that is configured to filter out or prevent airborne particles in the surrounding environment from being inhaled by the user. The material also protects others from any airborne particles exhaled by the user.

These and other features of the present disclosure will become more apparent from the following description of the illustrative embodiments.

### BRIEF DESCRIPTION OF THE DRAWINGS

FIG. 1 is a perspective view of a person wearing a disposable face mask adapted for covering a nose and mouth of a user to form a barrier around the nose and mouth of the user from the surrounding atmosphere showing that the face mask includes a mask body and attachment bands, the mask body being formed from a mask blank made of a single sheet of material that is configured to change from an unfolded arrangement as shown in FIG. 2, a folded arrangement as shown in FIG. 3, and a flat-folded arrangement as shown in FIG. 4;

FIG. 2 is a plan view of the disposable face mask of FIG. 1 in the unfolded arrangement in which the mask body is a two-dimensional sheet of material;

FIG. 3 is a perspective view of the disposable face mask of FIG. 1 in the folded arrangement in which the mask blank is formed into a three-dimensional shape using origami techniques so that the mask body forms an cavity sized to receive the nose and mouth of the user and a perimeter edge that contacts a face of the user around the nose and mouth;

FIG. 4 is a perspective view of the disposable face mask in the flat-foldable arrangement in which the mask blank remains folded in the folded arrangement with the cavity collapsed so that the mask body is flat along a two-dimensional plane;

FIG. 5 is a plan view of the disposable face mask of FIG. 1 in the unfolded configuration showing the different fold lines

FIG. 6 is a diagrammatic view of a process of changing the face mask of FIG. 1 from the unfolded arrangement to the folded arrangement;

FIG. 7 is a diagrammatic view of the process of FIG. 6 showing the steps of forming the mask blank for the mask body;

FIG. 8 is a diagrammatic view of the process of FIG. 6 showing the steps of forming a nose bridge of the mask body;

FIG. 9 is a diagrammatic view of the process of FIG. 6 showing the steps of folding the mask blank to form the sides of the mask body;

FIG. 10 is a diagrammatic view of the process of FIG. 6 showing the steps of folding first and second pleat folds to form the curvature shape of the mask body;

FIG. 11 is a diagrammatic view of the process of FIG. 6 showing the steps of coupling the attachment bands to the mask body; and

FIG. 12 is a front view of the face mask of FIG. 1 showing the mask body in the folded arrangement;

FIG. 13 is an elevation view of the disposable face mask of FIG. 1 in the unfolded configuration showing the different template sizes for the mask blank;

FIG. 14 is a side elevation view of another embodiment of a disposable face mask showing the face mask includes a mask body, a single attachment band coupled to the mask body;

FIG. 15 is another side elevation view of the face mask of FIG. 14 showing the face mask further includes a seal arranged around a perimeter of the mask body when the mask body is in a folded arrangement;

FIG. 16 is a plan view of the disposable face mask of FIG. 14 in an unfolded configuration showing the mask body includes a main portion, an upper attachment tab that extends from an upper edge of the main portion to help secure a portion of the attachment band to the mask body, and a bottom attachment tab that extends from a bottom edge of the main portion to help secure another portion of the attachment band to the mask body;

FIG. 17A is a plan view of another embodiment of a disposable face mask in an unfolded configuration showing the disposable face mask includes a mask body with a vertical fold line and pleat folds that are each formed by a valley fold line and a mountain fold line that extends at an angle relative to the valley fold line;

FIG. 17B is a front view of the disposable face mask of FIG. 17A showing the disposable face mask in the folded configuration such that the pleat folds form a middle section of the mask body into a triangular shape;

FIG. 17C is a diagrammatic view of a process of changing the face mask of FIG. 17A from the unfolded arrangement to the folded arrangement;

FIG. 18A is a plan view of another embodiment of a disposable face mask in an unfolded arrangement showing the disposable face mask includes a mask body with a vertical fold line and pleat folds that are each formed by a mountain fold line and a valley fold line that extends at an angle relative to the valley fold line;

FIG. 18B is a front view of the disposable face mask of FIG. 18A showing the disposable face mask in the folded configuration such that the pleat folds form a middle section of the mask body into a square shape;

FIG. 18C is a diagrammatic view of a process of changing the face mask of FIG. 18A from the unfolded arrangement to the folded arrangement;

FIG. 19A is a plan view of another embodiment of a disposable face mask in an unfolded arrangement showing the disposable face mask includes a mask body with a vertical fold line and pleat folds that are each formed by a combination of alternating mountain and valley fold lines;

FIG. 19B is a front view of the disposable face mask of FIG. 19A showing the disposable face mask in the folded configuration such that the pleat folds form a middle section of the mask body into a quadrilateral shape;

FIG. 19C is a diagrammatic view of a process of changing the face mask of FIG. 19A from the unfolded arrangement to the folded arrangement;

FIG. 20 is a perspective view of another embodiment of a face mask configured to change from an unfolded arrangement, a folded arrangement, and a flat-folded arrangement;

FIG. 21 is a plan view of the face mask of FIG. 20 disassembled showing the face mask includes a mask body comprising a mask sleeve and a filter insert configured to fit in the mask sleeve, an attachment band configured to be coupled to the mask body, and a plurality of snap buttons configured to be selectively coupled to the mask body to hold the mask body together in the folded arrangement and the flat-folded arrangement;

FIG. 22 is a plan view of the mask sleeve included in the face mask of FIG. 21 showing an interior side of the mask sleeve and showing the mask sleeve includes a first panel and a second panel adjacent to the first panel to define a filter slot for the filter insert, and further showing the second panel is coupled to the first panel at the upper and bottom edges so that the side edges are free to allow the filter insert to be inserted into the filter slot between the first panel and the second panel;

FIG. 23 is a diagrammatic view of a process of changing the face mask of FIG. 20 from the unfolded arrangement to the folded arrangement by inserting the filter insert into the mask sleeve, folding the mask body along the first and second pleat folds, and attaching the attachment band to the mask body;

FIG. 24 is a diagrammatic view of the face mask of FIG. 20 showing the snap buttons are selectively adjustable to allow the user to adjust the first pleat fold so that the face mask may be fitted to the face of the user;

FIG. 25 is a view similar to FIG. 24 showing the second pleat fold is also adjustable using the snap buttons;

FIG. 26 is a view similar to FIG. 25 showing both the first and second plate folds are adjustable by selectively coupling the snap buttons to the mask body in a different location; and

FIG. 27 is a front, rear, and side view of the face mask of FIG. 20 being worn by the user showing the attachment band wraps around the neck of the user above the ears of the user.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

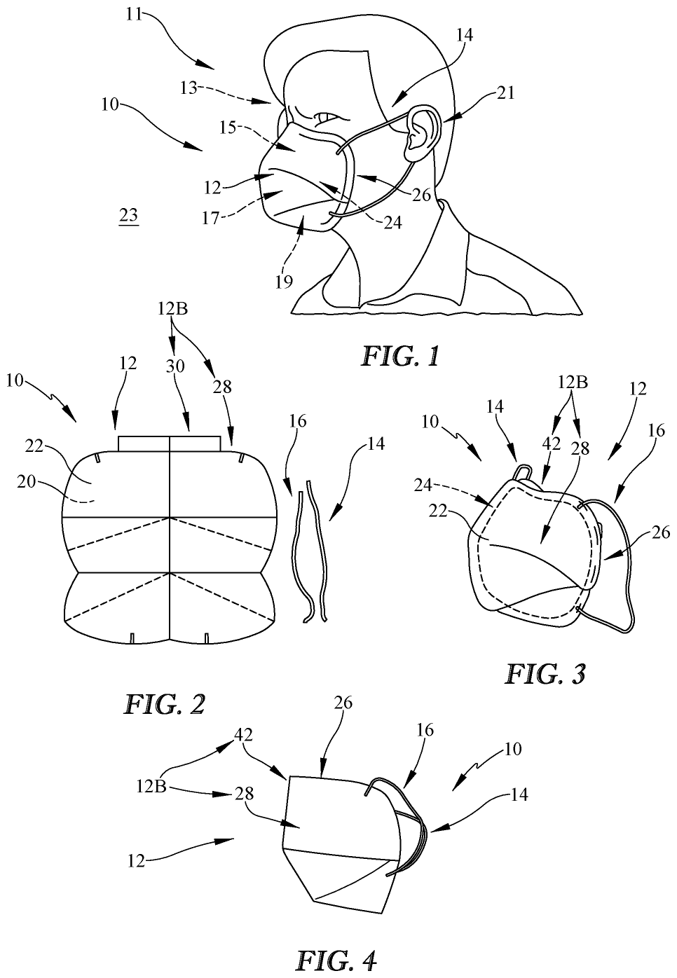

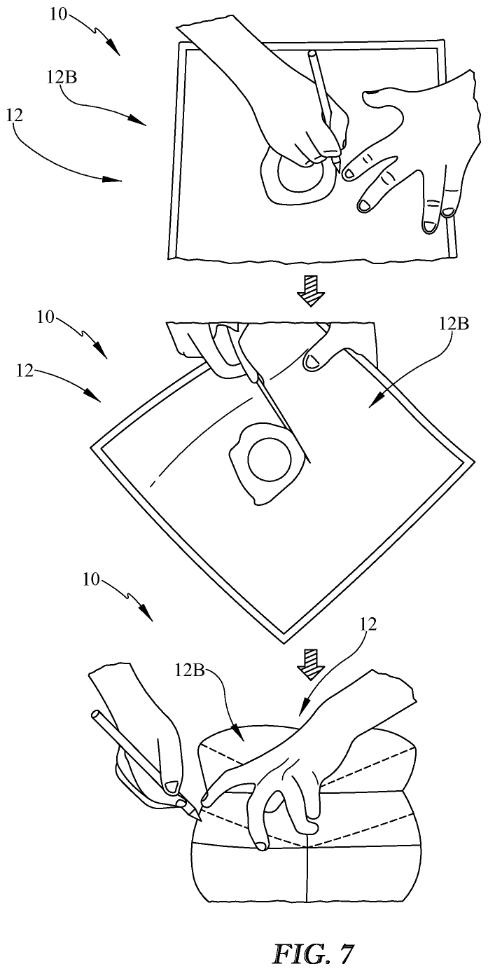

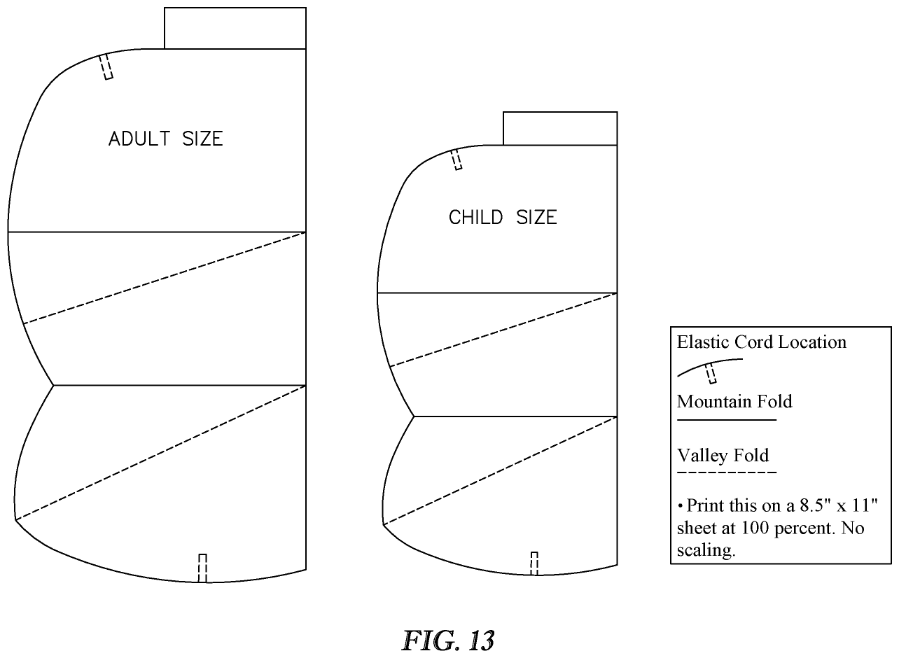

A first embodiment of a face mask 10 adapted for covering a nose 15 and mouth 17 of a user 11 is shown in FIGS. 1-13. The disposable face mask 10 covers the nose 15 and mouth 17 of the user 11 to form a barrier between the nose 15 and mouth 17 of the user 11 and the surrounding atmosphere 23. The disposable face mask 10 includes a mask body 12 and at least one attachment band 14, 16 coupled to the mask body 12 and configured to secure the mask body 12 to a face of the user around the nose and mouth as shown in FIG. 1-11. The mask body 12 is formed from a mask blank 12B made of a single two-dimensional sheet of material and is configured to change between an unfolded arrangement as shown in FIG. 2, a folded arrangement as shown in FIG. 3, and a flat-folded arrangement as shown in FIG. 4 using origami techniques as shown in FIGS. 4 and 7-11.

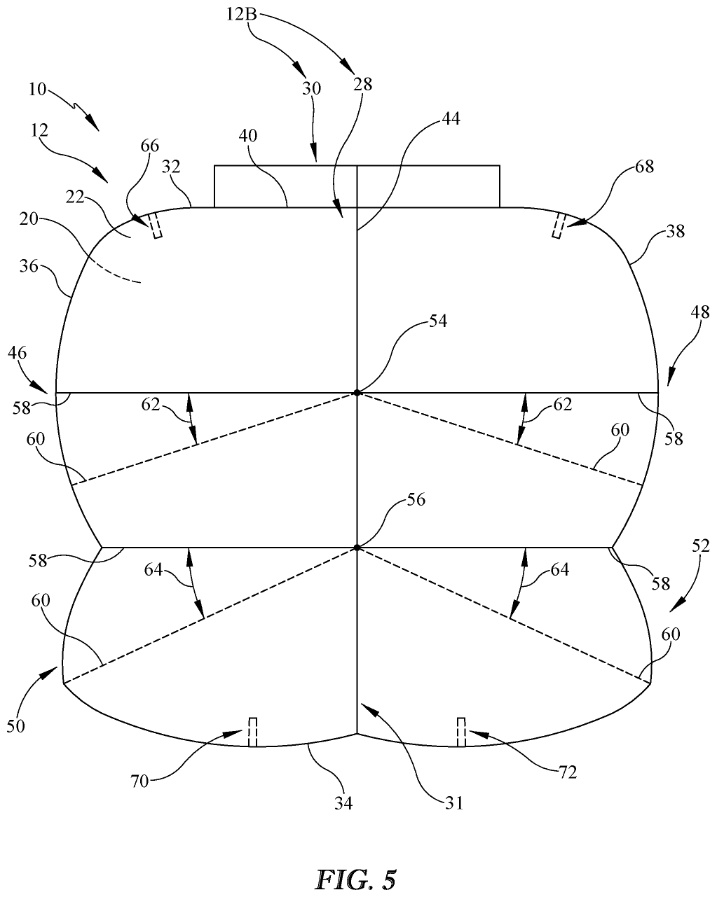

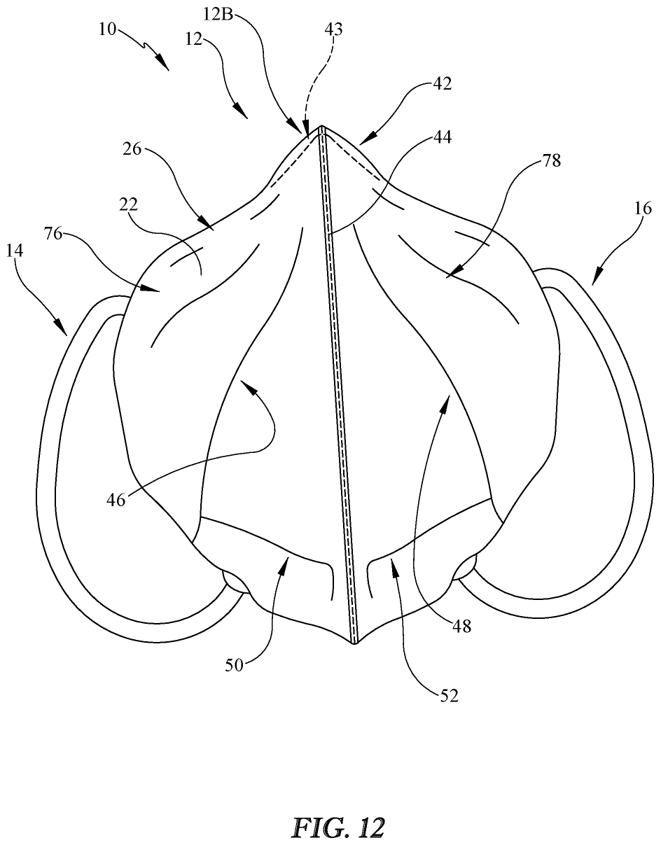

In the unfolded arrangement, the mask blank 12B remains in a flat-two dimensional shape having a first surface 20, a second surface 22 opposite the first surface 20, and outer edges 32, 34, 36, 38 as shown in FIGS. 2, 5-6, 8, and 9-10. The outer edges 32, 34, 36, 38 of the mask blank 12B may be configured to form a pattern outline or template as shown in FIGS. 5 and 12. The pattern outline is configured to allow the mask body 12 to provide an adequate seal with the face 13 of the user 11 when in the folded arrangement.

In the folded arrangement, the mask blank 12B is formed into a three-dimensional shape using origami techniques so that the mask body 12 forms a cavity 24 and a perimeter edge 26 as shown in FIGS. 1 and 3. The cavity 24 is sized to receive the nose 15 and mouth 17 of the user 11. The perimeter edge 26 is configured to contact the face 13 of the user 11 around the nose and mouth so that the mask body is spaced apart from the nose and mouth of the user in the cavity. In the illustrative embodiment, the first surface 20 of the mask blank 12B forms a majority of the cavity 24, while the outer edges 32, 34, 36, 38 from a majority of the perimeter edge 26 when the mask body 12 is in the folded arrangement.

In the flat-folded arrangement, the mask blank 12B remains folded in three-dimensional shape of the folded arrangement with the cavity 24 collapsed so that the mask body 12 is flat. The flat-folded arrangement allows the face mask 10 to take up less space, which allows the face mask 10 to be easily packed for storage or shipping.

Surgical masks or other protective face masks are helpful in preventing contaminant or harmful airborne particles from passing person to person, but do not always provide an airtight fit to the user 11. In an event of a respiratory virus pandemic like that of the COVID-19 virus, people may be required to wear medical respirators, i.e. medical N95 respirators that are configured to block out 95 percent of airborne particles. These medical respirators provide a better fit between the face 13 of the user 11 and the mask to provide a better barrier for blocking airborne particles compared to common surgical masks. However, such medical respirators can be expensive and uncomfortable if worn for long hours.

The disposable face mask 10 disclosed herein provides an inexpensive and readily available mask option compared to medical respirators. By using origami techniques to form the single two-dimensional sheet of material, the mask blank 12B can be folded into the three-dimensional shape that provides a custom fit to the user 11. The origami techniques used to fold the face mask 10 allows the three-dimensional shape of the mask body 12 to be adjustable to fit the face of the user 11.

Origami is the art of forming a single sheet of material into a three-dimensional shape without cutting or making holes in the sheet of material. The origami techniques used to form the folded arrangement of the mask body 12 are adapted from an origami technique that uses two Miura-ori vertices that are aligned in the direction of the fold that divides the sheet of material in symmetric halves. Each Miura-ori vertex is also called a bird's food vertex, and it is a four-degree vertex that has four crease lines meeting at the vertex point. The present disposable face mask 10 uses an origami technique similar to the Miura-ori vertices that use two six-degree vertices (the six degree vertices has six crease lines meeting at the vertex point). Changing the locations of two of the six crease lines in turn allows the mask body 12 to be adjustable to fit the face 13 of the user 11.

The mask blank 12B from which the mask body 12 is folded is made of a single sheet of material that is configured to filter out or prevent airborne particles in the surrounding atmosphere 23 from being inhaled by the user 11. The material also protects others from any airborne particles exhaled by the user 11.

In the illustrative embodiment, the sheet of material of the mask blank 12B is a synthetic material configured to filter airborne particles from being transferred between the surrounding atmosphere 23 and the user 11. In some embodiments, the synthetic material is one of a non-woven synthetic material and a woven synthetic material. In the preferred embodiments, the synthetic material is a non-woven synthetic material.

In the illustrative embodiments, the synthetic material is polyethylene. Specifically, in some embodiments, the synthetic material may be a PFTE or polyester material such as those used in HEPA vacuum filters or MERV rated air filters. In other embodiments, the sheet of material may also be water resistant.

In other embodiments, the synthetic material may be other suitable paper-like or fabric-like material typically used in protective respiratory devices that can provide high-level protection against fluids and particles. The paper-like or fabric-like material typically used in protective respirator devices is also strong and resistant to tears, naturally low-linting, and breathable. The paper/fabric-like material may be a single layer or have multiple layers. The paper-like and fabric-like material may also be a composite material of a similar or different material layer count. A three-layer mask may have an outer layer that is water resistant, a middle layer that is efficient at filtering, and an inner layer that is comfortable when worn against the skin of the user 11.

Turning again to the mask blank 12B of the mask body 12, the mask blank 12B includes a main portion 28 and a nose bridge tab 30 as shown in FIGS. 2, 5-6, and 8. The main portion 28 forms an upper edge 32, a bottom edge 34 spaced apart from the upper edge 32, and side edges 36, 38 that extend between and interconnect the upper and bottom edges 32, 34 when the mask body 12 is in the unfolded arrangement. The nose bridge tab 30 extends from the upper edge 32 of the main portion 28 along a horizontal fold line 40. The nose bridge tab 30 is configured to be folded along the horizontal fold line 40 vertically downward onto the main portion 28 to form a nose bridge 42 of the mask body 12 when the mask body 12 is in the folded arrangement.

In the illustrative embodiment, the upper edge 32 forms a majority of the perimeter edge 26 that extends over the nose, while the bottom edge 34 forms a majority of the perimeter edge 26 that extends over a chin 19 of the user 11 when the mask body 12 is in the folded arrangement. The side edges 36, 38 form a majority of the perimeter edge 26 that extends over cheeks of the user 11 when the mask body 12 is in the folded arrangement.

The main portion 28 is formed to include a vertical fold line 44, first pleat folds 46, 48, and second pleat folds 50, 52 as shown in FIGS. 5-6, 8-9, and 10-11. The vertical fold line 44 extends between the upper edge 32 and the bottom edge 34 of the main portion 28 at a center 31 of the main portion 28. The first and second pleat folds 46, 48, 50, 52 are mirrored over the center 31 of the main portion 28 and are configured to form the curvature of the mask body 12 that shapes the mask body 12 to the face 13 of the user 11 when in the mask body 12 is in the folded arrangement.

The first pleat folds 46, 48 extend from the vertical fold line 44 to the corresponding side edge 36, 38 of the main portion 28. The second pleat folds 50, 52 extend from the vertical fold line 44 to the corresponding side edge 36, 38 of the main portion 28 vertically between the first pleat folds 46, 48 and the bottom edge 34.

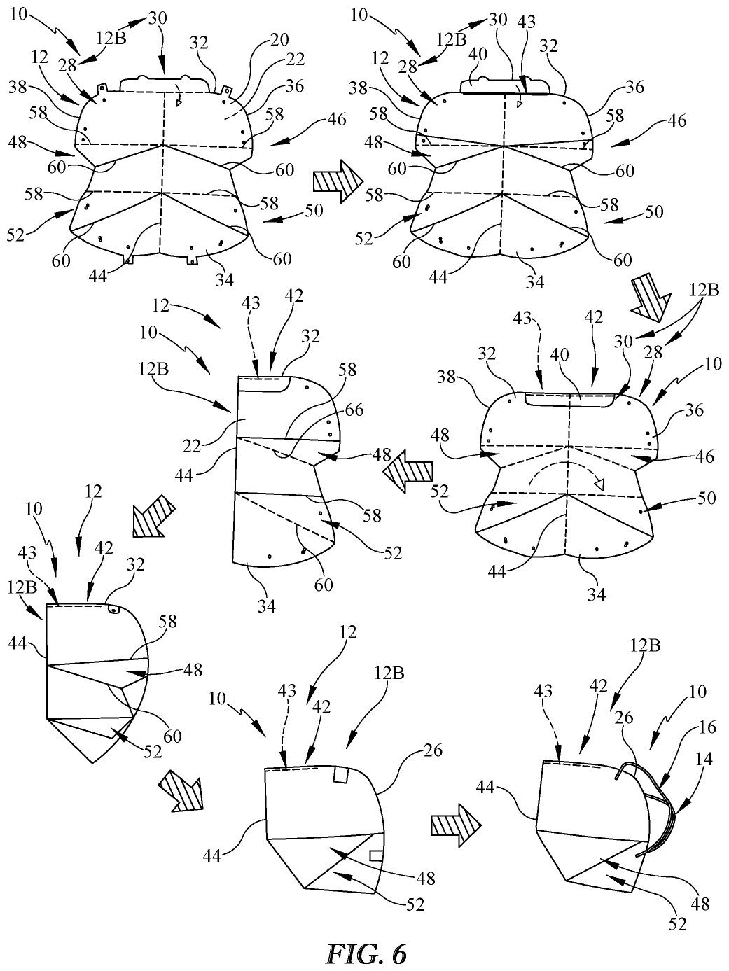

The first pleat folds 46, 48 converge at a first vertex 54, while the second pleat folds 50, 52 converge at a second vertex 56 as shown in FIGS. 5 and 6. The first vertex 54 is located on the vertical fold line 44. The second vertex 56 is located on the vertical fold line 44 vertically between the first vertex 54 and the bottom edge 34.

Each pleat fold 46, 48, 50, 52 includes a mountain fold line 58 and a valley fold line 60 as shown in FIGS. 5 and 6. The mountain fold lines 58 extend between the corresponding vertex 54, 56 and the corresponding side edge 36, 38. The valley fold lines 60 extend from the corresponding vertex 54, 56 to the corresponding side edge 36, 38 at an angle 62, 64 relative to the mountain fold lines 58. Together the mountain and valley fold lines 58, 60 form the pleat fold 46, 48, 50, 52 when the mask body 12 is in the folded arrangement.

In the illustrative embodiments, the mountain and valley folds 58, 60 depend on the orientation of the mask body 12. When viewed from the first surface 20 as shown in FIGS. 5 and 6, the fold line 58 is a valley fold and the fold link 60 is a mountain fold. Conversely, when viewed from the second surface 22 as shown in FIG. 2, the fold lines 58, 60 are opposite, such that the fold line 58 is viewed as a mountain fold and the fold line 60 is viewed and a valley fold 60.

To adjust the fit of the mask body 12 to the face of the user, the user may vary the location of the vertices 54, 56 along the vertical fold line 44, the angle 62, 64 of the pleat folds 46, 48, 50, 52, and/or the pattern shape of the mask blank 12B when changing the mask body 12 from the unfolded arrangement to the folded arrangement.

In the illustrative embodiments, the location of at least one of the first vertex 54 and the second vertex 56 is adjustable along the vertical fold line 44 to vary the size of the perimeter edge 26 of the mask body 12 when the mask body 12 is in the folded arrangement. In other embodiments, both the location of the first vertex 54 and the second vertex 56 are adjusted simultaneously to vary the size of the mask body 12.

In the illustrative embodiments, the angle 62, 64 between the mountain fold line 58 and the valley fold line 60 is adjustable to vary the size of the perimeter edge 26 of the mask body 12 when the mask body 12 is in the folded arrangement. In some embodiments, only the angles 62, 64 of the first pleat folds 46, 48 may be adjusted. In some embodiments, only the angles 62, 64 of the second pleat folds 50, 52 may be adjusted. In other embodiments, both angles 62, 64 of the first and second pleat folds 46, 48, 50, 52 may be adjusted simultaneously to vary the size of the mask body 12.

In other embodiments, the patter outline or template as shown in FIG. 12 may be adjusted to vary the shape of the perimeter edge 26 of the mask body 12 in the folded arrangement. The shape of the outer edges 32, 34, 36, 38 may be altered to vary the size and shape of the perimeter edge 26 when the mask body 12 is in the folded arrangement.

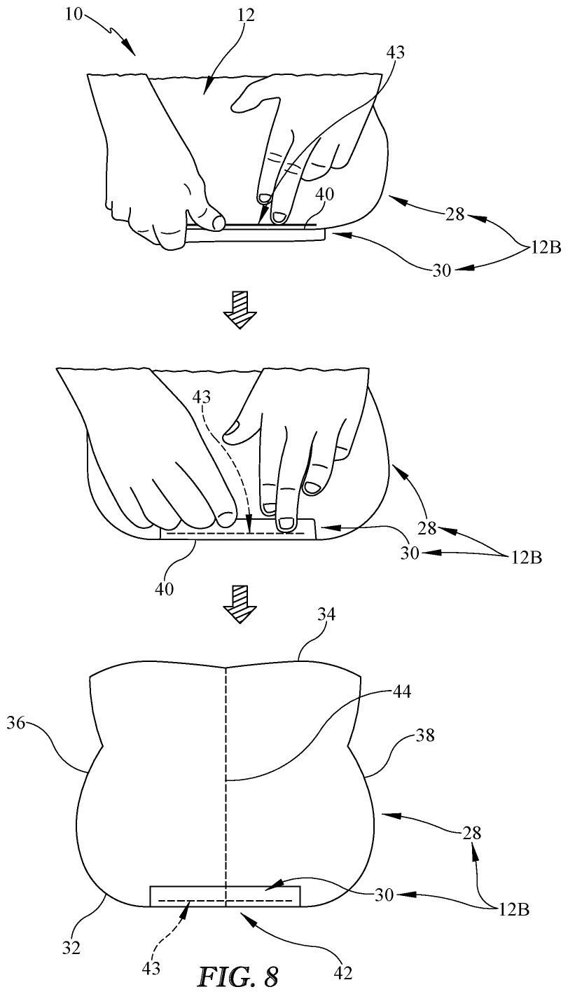

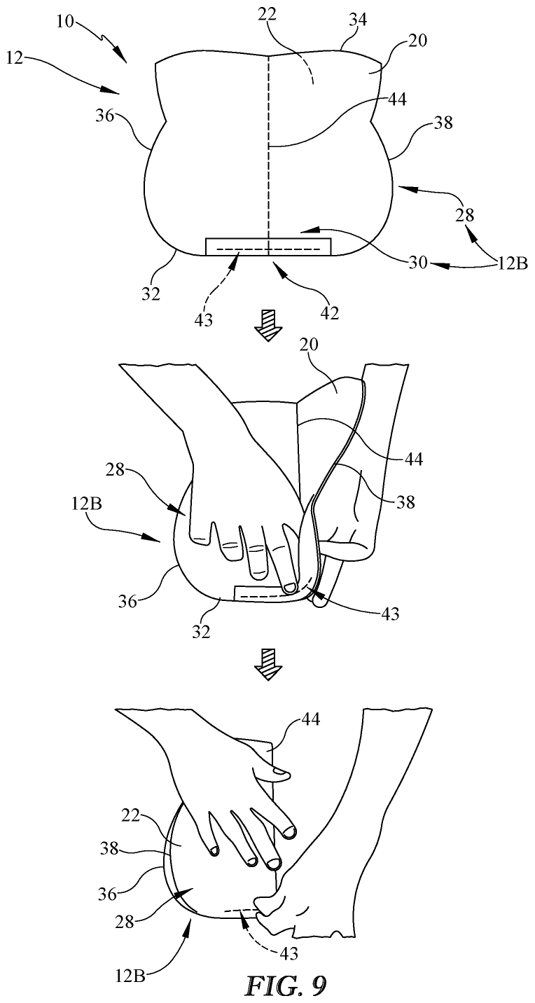

The method of forming the mask body 12 into the folded arrangement from the unfolded arrangement includes several steps as shown in FIGS. 6-10. To begin the nose bridge 42 of the mask body 12 is formed as shown in FIGS. 6 and 8. The nose bridge 42 is formed by folding the nose bridge tab 30 along the horizontal fold line 40 so that the nose bridge tab 30 folds over and onto the main portion 28 of the mask blank 12B.

In some embodiments, the mask body 12 may include a wire 43 to stiffen the nose bridge 42 as shown in FIGS. 6, 8-9, and 11. The wire 43 may be arranged along the horizontal fold line 40 before the nose bridge tab 30 is folded over onto the main portion 28. In this way, the wire 43 is arranged between the nose bridge tab 30 and the main portion 28 and the nose bridge tab 30 protects the nose 15 of the user from directly contacting the wire 43.

In the illustrative embodiment, the nose bridge tab 30 is secured to the main portion 28 once the nose bridge tab 30 is folded to secure the wire 43 in place. The nose bridge tab 30 may be secured using a mechanical fastener, such as staples in some embodiments. In other embodiments, the nose bridge tab 30 may be secured using an adhesive, such as glue. In some embodiments, the nose bridge tab 30 is held in place by the subsequent folds to form the mask body 12 into the folded arrangement.

Next, the main portion 28 is folded along the vertical fold line 44 as shown in FIGS. 6 and 9. The main portion 28 is folded along the vertical fold line 44 in such a way the first surface 20 of the mask blank 12B is folded onto itself. The main portion 28 on either side of the vertical fold line 44 begins to form sides 76, 78 of the mask body 12 as shown in FIG. 12.

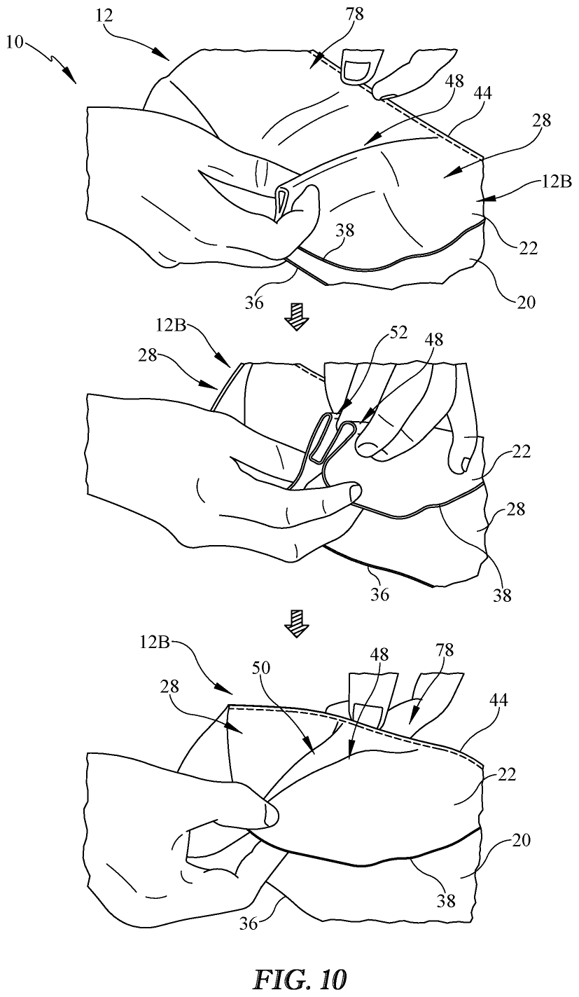

Once the main portion 28 is folded in half along the vertical fold line 44, the pleat folds 46, 48, 50, 52 may be folded for each side 76, 78 of the mask blank 12B. In the illustrative embodiment, the first pleat folds, 48, 52 are formed first. The first pleat fold 48 is formed for one side 78 of the mask blank 12B as shown in FIG. 10. The first pleat fold 48 is formed by pleat folding the mask blank 12B along the fold lines 58, 60 of the first pleat fold 48.

Next, the second pleat fold 52 is formed for the same side 78 of the mask blank 12B as shown in FIG. 10. The second pleat fold 52 is formed in a similar manner as the first pleat fold 48. With the first pleat fold 48 in place, the second pleat fold 52 by pleat folding the mask blank 12B along the fold lines 58, 60 of the second pleat fold 52.

In the illustrative embodiment, once the first and second pleat folds 48, 52 are formed for one side 78 of the mask blank 12B, the first and second pleat folds 48, 52 are secured in place. The first and second pleat folds 48, 52 are secured using a mechanical fastener like the mechanical fastener used to form the nose bridge 42 in the illustrative embodiment. In other embodiments, the first and second pleat folds 48, 52 are secured using an adhesive.

With the first and second pleat folds 48, 52 secured for the one side 78 of the mask blank 12B, the steps are repeated for the first and second pleat folds 46, 50 on the other side 76 of the mask blank 12B. Each of the first and second pleat folds 46, 50 are formed by the mask blank 12B along the mountain fold lines 58, 60 of the corresponding pleat fold 46, 50. Then first and second pleat folds 46, 50 are secured in place using a similar method used for the first and second pleat folds 48, 50 of the other side 78.

In the illustrative embodiment of FIG. 6, the second pleat folds 50, 52 are formed together before the first pleat folds 46, 48 are formed. In other embodiments, the order of forming the first pleat folds 46, 48 and second pleat folds 50, 52 may be different.

Once both the first and second pleat folds 46, 48, 50, 52 for each side 76, 78 of the mask blank 12B are formed and secured, the sides 76, 78 of the mask body 12 may be pulled away from each other to open the cavity 24 as shown in FIGS. 3 and 12. With the mask blank 12B in the three-dimensional shape, the mask body 12 is now in the folded arrangement.

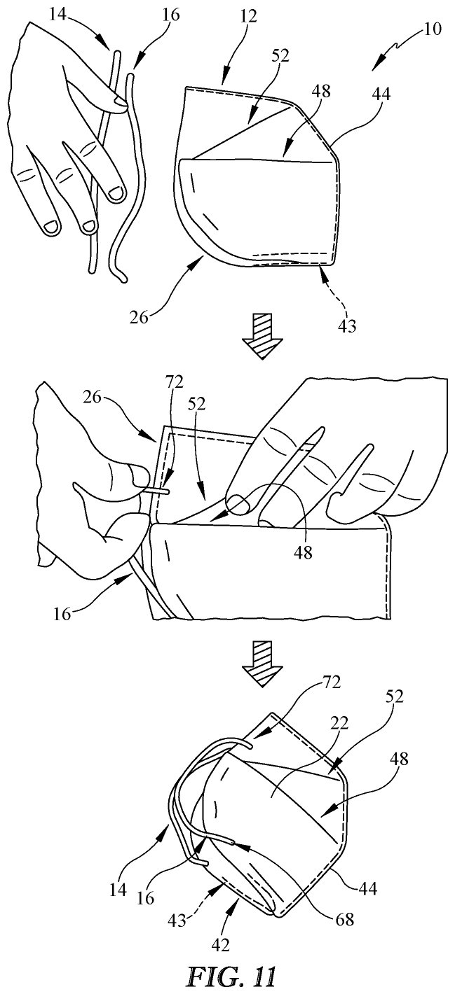

The next step includes coupling the attachment bands 14, 16 to the mask body 12 as shown in FIGS. 6 and 11. The attachment bands 14, 16 are coupled to the perimeter edge 26 of the mask body 12 on opposite sides 76, 78 of the mask body 12 in the illustrative embodiment.

The first attachment band 14 is coupled to the first side 76 of the mask body 12. The ends of the attachment band 14 are coupled to the mask blank 12B are the location points 66, 70 as shown in FIG. 5 once the mask body 12 is in the folded arrangement.

The second attachment band 16 is coupled to the second side 78 of the mask body 12. The ends of the attachment band 16 are coupled to the mask blank 12B are the location points 68, 72 as shown in FIG. 5 once the mask body 12 is in the folded arrangement.

In some embodiments, the location points 66, 68, 70, 72 are instead attachment tabs 66, 68, 70, 72 that extend from the main portion 28 of the mask body 28. The attachment tabs 66, 68, 70, 72 are configured to be folded over the corresponding attachment band 14, 16 to help secure the attachment band 14, 16 to the mask body 12. A mechanical fastener may be used to secure the attachment tabs 66, 68, 70, 72 with the end of the attachment band 14, 16 in place.

In other embodiments, at least one attachment band 14, 16 is coupled to the mask body 12 and configured to extend between mask body 12 and the user to secure the mask body 12 in place on the face 13 of the user 11 when the mask body is in the folded arrangement. The attachment band 14, 16 may extend from one side of the mask body 12, around the head of the user 11 and to the other side of the mask body 12.

In illustrative embodiments, the face mask 10 include two attachment bands 14, 16 that are configured to be arranged around the ear 21 of the user 11. Together the attachment bands 14, 16 secure the mask body 12 in place on the face 13 of the user 11 when the mask body is in the folded arrangement so that the perimeter edge 26 contacts the face 13 of the user 11 at all points around the nose 15 and mouth 17 of the user 11 as shown in FIG. 1.

With the attachment bands 14, 16 secured to the mask body 12, the face mask 10 can then be worn by the user 11 by arranging the nose 15 and mouth 17 of the user 11 in the cavity 24 so that the perimeter edge 26 extends around the nose 15, mouth 17, and chin 19 of the user 11. Each attachment band 14, 16 is then arranged over the respective ear 21 of the user 11 to bring the perimeter edge 26 of the mask body 12 into contact with the face 13 of the user 11 and secure the mask body 12 to the face 13 of the user 11.

The perimeter edge 26 is configured to contact the face 13 of the user 11 are all points around the nose 15 and mouth 17 of the user 11 to form a seal therebetween. If the perimeter edge 26 does not contact the face 13 of the user 11 in all the necessary areas, the different components of the mask body 12 may be adjusted as discussed above to ensure a good fit for the user 11.

To change the mask body 12 from the folded arrangement to the flat-folded arrangement when the user 11 is not wearing the face mask 10, the mask body 12 is folded along the vertical fold line 44 again so that the sides of the mask body 12 are brought together. In doing so, the first surface 20 contacts itself to collapse the cavity 24 of the mask body 12 so that the sides on either side of the vertical fold line 44 are parallel. This causes the mask body 12 to be flat allowing for easy storage or packaging for shipping.

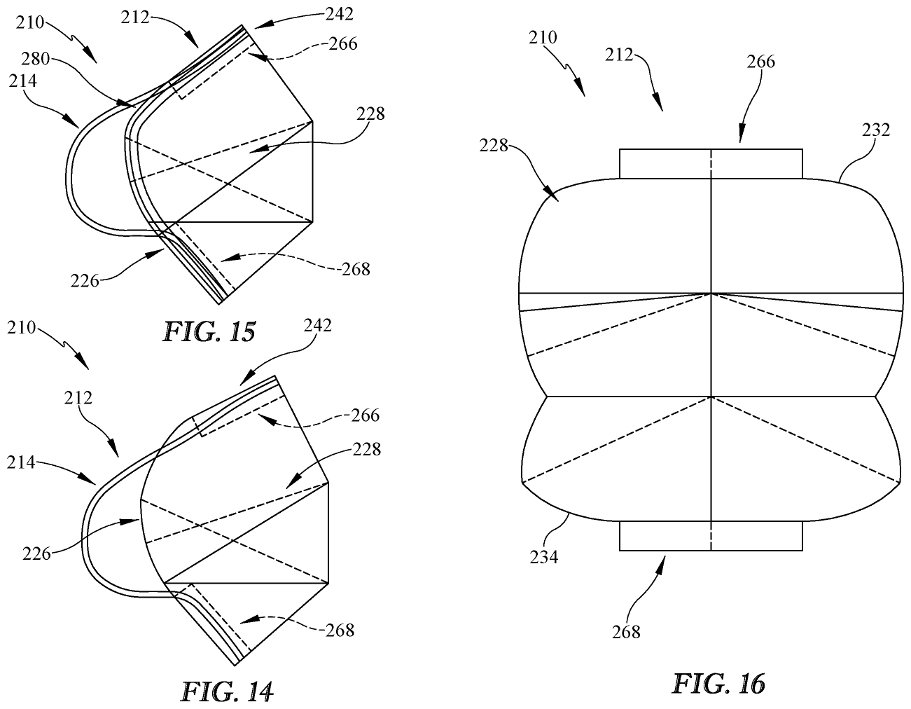

Another embodiment of a disposable face mask 210 in accordance with the present disclosure is shown in FIGS. 14-16. The disposable face mask 210 is substantially similar to the disposable face mask 10 shown in FIGS. 1-13 and described herein. Accordingly, similar reference numbers in the 200 series indicate features that are common between the disposable face mask 10 and the disposable face mask 210. The description of the disposable face mask 10 is incorporated by reference to apply to the disposable face mask 210, except in instances when it conflicts with the specific description and the drawings of the disposable face mask 210.

The disposable face mask 210 includes the mask body 212 and at least one attachment band 214 as shown in FIGS. 14-16. The attachment band 214 arise coupled to the mask body 212 and configured to secure the mask body 212 on the face 13 of the user 11.

The mask body 212 includes a main portion 228, an upper attachment tab, and a bottom attachment tab 268 as shown in FIGS. 14-16. The upper tab 266 extends from an upper edge 232 of the main portion 228 and the bottom tab 268 extends form a bottom edge 234 of the main portion 228. Each of the attachment tabs 266, 268 are configured to fold over the attachment band 214 and help couple the attachment band 214 to the mask body 212.

In the illustrative embodiment, the upper tab 266 along with the attachment band 214 form the nose bridge 242 of the mask body 212 as shown in FIGS. 14-16. In the illustrative embodiment, the face mask 210 further includes a seal 280 arranged around the perimeter edge 226 of the mask body 212 when the mask body 212 is in the folded arrangement.

The seal 280 is configured to be elastic and/or compressible so that the mask body 212 can change between the folded and flat-folded arrangements. The elasticity of the seal 280 also allows the mask body 212 to be adjustable. The seal 280 also helps form a good fit with the face 13 of the use 11.

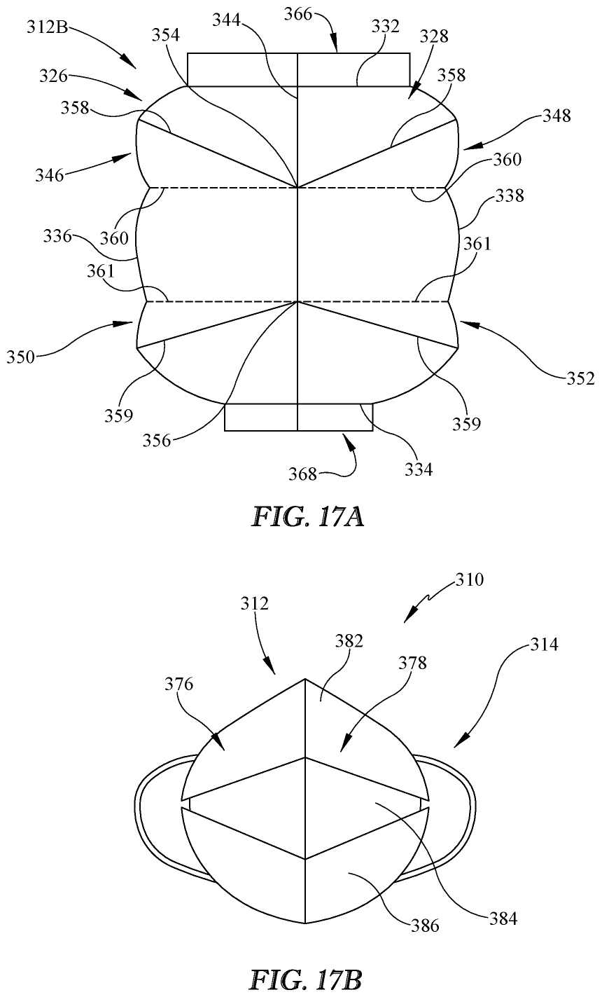

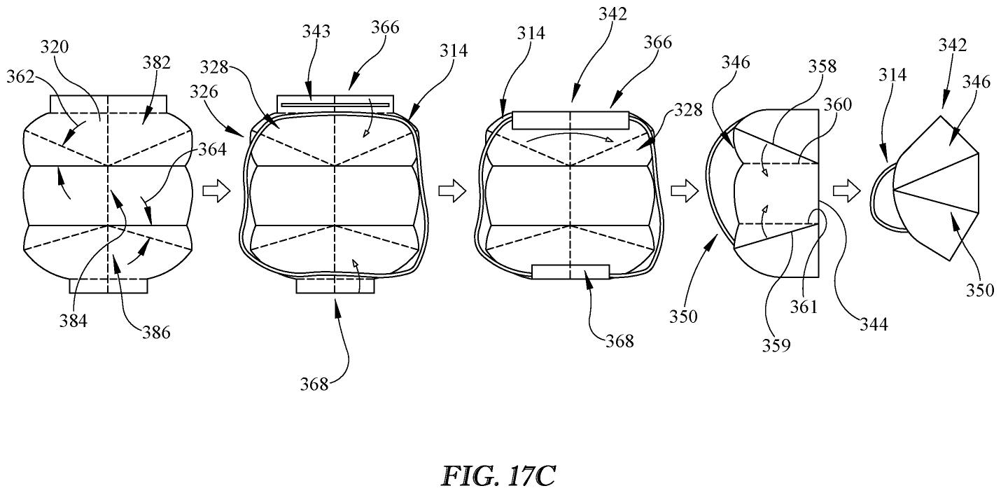

Another embodiment of a disposable face mask 310 in accordance with the present disclosure is shown in FIGS. 17A-17C. The disposable face mask 310 is substantially similar to the disposable face mask 10 shown in FIGS. 1-13 and described herein. Accordingly, similar reference numbers in the 300 series indicate features that are common between the disposable face mask 10 and the disposable face mask 310. The description of the disposable face mask 10 is incorporated by reference to apply to the disposable face mask 310, except in instances when it conflicts with the specific description and the drawings of the disposable face mask 310.

The disposable face mask 310 includes the mask body 312 and at least one attachment band 314 as shown in FIGS. 17A-17C. The attachment band 314 is coupled to the mask body 312 and configured to secure the mask body 312 on the face 13 of the user 11.

In the illustrative embodiment, the attachment band 314 is a single continuous loop as shown in FIGS. 17A-17C. The attachment band 314 forms ear loops for each side 376, 378 of the mask body 312 once the attachment band 314 is coupled to the mask body 312 in the folded arrangement. The ear loops of the attachment band 314 may then be placed over the respective ear 21 of the user 11 to secure the mask body 312 to the face 13 of the user 11.

The mask body 312 includes a main portion 328, an upper attachment tab 366, and a bottom attachment tab 368 as shown in FIGS. 17A-17C. The upper tab 366 extends from an upper edge 332 of the main portion 328 and the bottom tab 368 extends form a bottom edge 334 of the main portion 328. Each of the attachment tabs 366, 368 are configured to fold over the attachment band 314 and help couple the attachment band 314 to the mask body 312.

In the illustrative embodiment, the upper attachment tab 366 is larger than the bottom attachment tab 368 as shown in FIGS. 17A-17C. The upper attachment tab 366 is larger or extends over a larger portion of the upper edge 332 of the main portion 328 such that the ear loops of the attachment band 314 formed on each side 376, 378 by the attachment band 314 are in the correct position when the mask body 12 is in the folded arrangement. The position of the ear loops of the attachment band 314 may be important to ensure the perimeter edge 326 of the mask body 312 contacts the face 13 of the user 11 at all points around the nose 15 and mouth 17 of the user 11.

The main portion 328 is formed to include a vertical fold line 344, first pleat folds 346, 348, and second pleat folds 350, 352 as shown in FIGS. 17A-17C. The vertical fold line 344 extends between the upper edge 332 and the bottom edge 334 of the main portion 328 at a center of the main portion 328. The first and second pleat folds 346, 348, 350, 352 are mirrored over the vertical fold line 344 of the main portion 328 and are configured to form the curvature of the mask body 312 that shapes the mask body 312 to the face 13 of the user 11 when in the mask body 312 is in the folded arrangement.

The first pleat folds 346, 348 converge at a first vertex 354, while the second pleat folds 350, 352 converge at a second vertex 356 as shown in FIGS. 17A-17C. The first vertex 354 is located on the vertical fold line 344. The second vertex 356 is located on the vertical fold line 344 vertically between the first vertex 354 and the bottom edge 334.

Each pleat fold 346, 348, 350, 352 includes a mountain fold line 358, 359 and a valley fold line 360, 361 as shown in FIGS. 17A-17C. The valley fold lines 360, 361 extend from the corresponding vertex 354, 356 to the corresponding side edge 336, 338. The mountain fold lines 358, 359 extend between the corresponding vertex 354, 356 and the corresponding side edge 336, 338 at an angle 362, 364 relative to the valley fold lines 360, 361. Together the mountain and valley fold lines 358, 359, 360, 361 form the corresponding pleat fold 346, 348, 350, 352 when the mask body 312 is in the folded arrangement.

In the illustrative embodiment, the valley fold lines 360, 361 of the first and second pleat folds 346, 348, 350, 352 extend parallel relative to each other, while each of the mountain fold lines 358, 359 extend at the angle 362, 364 relative to the corresponding valley fold line 360. The mountain fold line 358 of the first pleat fold 346 extends at the angle 362 relative to the valley fold line 360 toward the upper edge 332 of the main portion 328. Conversely, the mountain fold line 359 of the second pleat fold 350 extends at the angle 364 relative to the valley fold line 361 toward the bottom edge 334 of the main portion 328. In this way, the mountain fold lines 358, 359 extend from the corresponding vertex 354, 356 in opposite directions. In the illustrative embodiment, the mountain and valley fold lines 358, 359, 360, 361 are mirrored over the vertical fold line 344 for the first and second pleat folds 348, 352 of the other side 378.

In the illustrative embodiment, the pattern outline or template of the perimeter edge 326 of the mask blank 312B is different from previous embodiments. Furthermore, by changing the angles 362, 364, as well as the overall length of the vertical fold liner 344, the perimeter edge 326 may be adjusted. In this way, the mask body 12, in various design alterations in dimensions, forms a complementary shape when in the folded arrangement such that the mask body 12 provides an adequate seal with the face 13 of the user 11.

In the illustrative embodiment, the mask blank 312B has an upper section 382, a middle section 384, and a bottom section 386 as shown in FIGS. 17A-17C. The upper section 382 is formed between the upper edge 332 and the valley fold lines 360 of the first pleat folds 346, 348. The bottom section 386 is formed between the bottom edge 334 and the valley fold lines 361 of the second pleat folds 350, 352. The middle section 384 is between the upper and bottom sections 382, 386 between the valley fold lines 360, 361.

By forming the pleat folds 346, 348, 350, 352, the upper and bottom sections 382, 386 fold onto a portion of the middle section 384. As such, the portion of the middle section 384 showing forms a triangular shape as shown in FIGS. 17A-17C.

The method of forming the mask body 312 into the folded arrangement from the unfolded arrangement includes several steps as shown in FIGS. 17A-17C. To begin the attachment band 314 is arranged around the perimeter edge 326 of the mask body 312. With a first surface 320 of the mask blank 312B facing away from a working surface used for folding the face mask 10, the attachment band 314 is arranged around the perimeter edge 326 such that the attachment band 314 overlaps the fold lines of the attachment tabs 366, 368.

Once the attachment band 314 is in place, the nose bridge 342 of the mask body 312 is formed as shown in FIGS. 17A-17C. The nose bridge 342 is formed by folding the upper attachment tab 366 so that the upper attachment tab 366 folds over and onto the main portion 328 of the mask blank 312B. By forming the nose bridge 342, the attachment band 314 is coupled to the mask blank 312B at the upper edge 332.

In some embodiments, the mask body 312 may include a wire 343 to stiffen the nose bridge 342 as shown in FIGS. 17A-17C. The wire 343 may be arranged along the fold line before the upper attachment tab 366 is folded over onto the main portion 328. In this way, the wire 343 is arranged between the upper attachment tab 366 and the main portion 328. In the illustrative embodiment, the upper attachment tab 366 is secured to the main portion 328 once the upper attachment tab 366 is folded to secure the wire 343 in place.

Similar steps are repeated for the bottom attachment tab 368 as shown in FIGS. 17A-17C. The bottom attachment tab 368 secures the attachment band 314 to the mask blank 312B at the bottom edge 334.

Next, the main portion 328 is folded along the vertical fold line 344 as shown in FIGS. 17A-17C. The main portion 328 is folded along the vertical fold line 344 in such a way the first surface 320 of the mask blank 312B is folded onto itself.

Once the main portion 328 is folded in half along the vertical fold line 344, the first pleat fold 346 is formed for a first side 376 of the mask blank 312B. The first pleat fold 346 is formed by pleat folding the mask blank 312B along the mountain fold lines 358 and the valley fold lines 360 of the first pleat fold 346.

Next, the second pleat fold 350 is formed for the first side 376 of the mask blank 312B as shown in FIGS. 17A-17C. The second pleat fold 350 is formed in a similar manner as the first pleat fold 346. With the first pleat fold 346 in place, the second pleat fold 350 by pleat folding the mask blank 312B along the mountain fold lines 359 and the valley fold lines 361 of the second pleat fold 350.

In the illustrative embodiment, once the first and second pleat folds 346, 350 are formed for the first side 376 of the mask blank 312B, the first and second pleat folds 346, 350 are secured in place. With the first and second pleat folds 346, 350 secured for the first side of the mask blank 12B, the steps are repeated for the first and second pleat folds 348, 352 on the other side 378 of the mask blank 312B.

Once both the first and second pleat folds 346, 348, 350, 352 for each side 376, 378 of the mask blank 312B are formed and secured, the sides 376, 378 of the mask body 312 may be pulled away from each other to open the cavity (not shown). With the mask blank 312B in the three-dimensional shape, the mask body 312 is now in the folded arrangement.

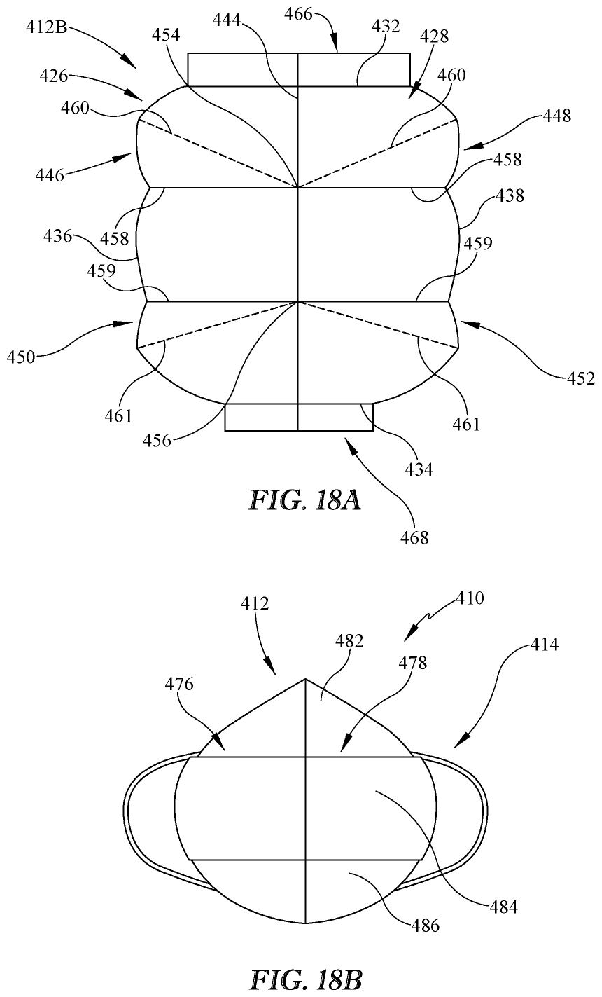

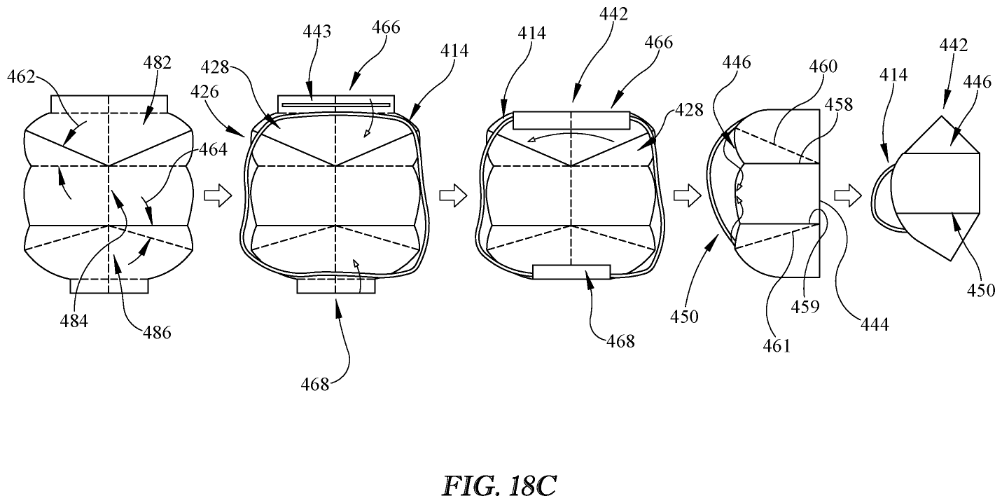

Another embodiment of a disposable face mask 410 in accordance with the present disclosure is shown in FIGS. 18A-8C. The disposable face mask 410 is substantially similar to the disposable face mask 10 shown in FIGS. 1-13 and described herein. Accordingly, similar reference numbers in the 400 series indicate features that are common between the disposable face mask 10 and the disposable face mask 410. The description of the disposable face mask 10 is incorporated by reference to apply to the disposable face mask 410, except in instances when it conflicts with the specific description and the drawings of the disposable face mask 410.

The disposable face mask 410 includes the mask body 412 and at least one attachment band 414 as shown in FIGS. 18A-8C. The attachment band 414 is coupled to the mask body 412 and configured to secure the mask body 412 on the face 13 of the user 11.

The mask body 412 includes a main portion 428, an upper attachment tab 466, and a bottom attachment tab 468 as shown in FIGS. 18A-8C. The upper tab 466 extends from an upper edge 432 of the main portion 428 and the bottom tab 468 extends form a bottom edge 434 of the main portion 428. Each of the attachment tabs 466, 468 are configured to fold over the attachment band 414 and help couple the attachment band 414 to the mask body 412.

In the illustrative embodiment, the upper attachment tab 466 is larger than the bottom attachment tab 468 as shown in FIGS. 18A-8C. The upper attachment tab 466 is larger or extend over a larger portion of the upper edge 432 of the main portion 428 such that the ear loops formed on each side 476, 478 by the attachment band 414 are in the correct position when the mask body 12 is in the folded arrangement. The position of the ear loops may be important to ensure the perimeter edge 426 of the mask body 412 contacts the face 13 of the user 11 at all points around the nose 15 and mouth 17 of the user 11.

In some embodiments, the upper and bottom attachment tabs 466, 468 are the same size. In other embodiments, the bottom attachment tab 468 may be larger than the upper attachment tab 466. In the illustrative embodiment, the size of the attachment tabs 466, 468 are adjustable to vary the fit of the disposable face mask 410 to the face 13 of the user 11.

The main portion 428 is formed to include a vertical fold line 444, first pleat folds 446, 448, and second pleat folds 450, 452 as shown in FIGS. 18A-8C. The vertical fold line 444 extends between the upper edge 432 and the bottom edge 434 of the main portion 428 at a center of the main portion 428. The first and second pleat folds 446, 448, 450, 452 are mirrored over the center 431 of the main portion 428 and are configured to form the curvature of the mask body 412 that shapes the mask body 412 to the face 13 of the user 11 when in the mask body 412 is in the folded arrangement.

The first pleat folds 446, 448 converge at a first vertex 454, while the second pleat folds 450, 452 converge at a second vertex 456 as shown in FIGS. 18A-8C. The first vertex 454 is located on the vertical fold line 444. The second vertex 456 is located on the vertical fold line 444 vertically between the first vertex 454 and the bottom edge 434.

Each pleat fold 446, 448, 450, 452 includes a mountain fold line 458, 459 and a valley fold line 460, 461 as shown in FIGS. 18A-8C. The mountain fold lines 458, 459 extend between the corresponding vertex 454, 456 and the corresponding side edge 436, 438. The valley fold lines 460, 461 extend from the corresponding vertex 454, 456 to the corresponding side edge 436, 438 at an angle 462, 464 relative to the mountain fold lines 458, 459. Together the mountain and valley fold lines 458, 459, 460, 461 form the pleat fold 446, 448, 450, 452 when the mask body 412 is in the folded arrangement.

In the illustrative embodiment, the mountain fold lines 458, 459 of the first and second pleat folds 446, 448, 450, 452 extend parallel relative to each other, while each of the valley fold lines 460, 461 extend at the angle 462, 464 relative to the corresponding mountain fold line 458, 459. The valley fold line 460 of the first pleat fold 446 extends at the angle 462 relative to the mountain fold line 458 toward the upper edge 432 of the main portion 428. Conversely, the valley fold line 461 of the second pleat fold 450 extends at the angle 464 relative to the mountain fold line 459 toward the bottom edge 434 of the main portion 428. In this way, the valley fold lines 460, 461 extend from the corresponding vertex 454, 456 in opposite directions. In the illustrative embodiment, the mountain and valley fold lines 458, 459, 460, 461 are mirrored over the vertical fold line 444 for the first and second pleat folds 448, 452 of the other side 478.

In the illustrative embodiment, the mask blank 412B has an upper section 482, a middle section 484, and a bottom section 486 as shown in FIGS. 18A-8C. The upper section 482 is formed between the upper edge 432 and the mountain fold lines 458 of the first pleat folds 446, 448. The bottom section 486 is formed between the bottom edge 434 and the mountain fold lines 459 of the second pleat folds 450, 452. The middle section 484 is between the upper and bottom sections 482, 486 between the valley fold lines 460, 461.

By forming the pleat folds 446, 448, 450, 452, the upper and bottom sections 482, 486 fold in onto themselves. As such, the portion of the middle section 484 showing forms a rectangular shape as shown in FIGS. 18A-8C.

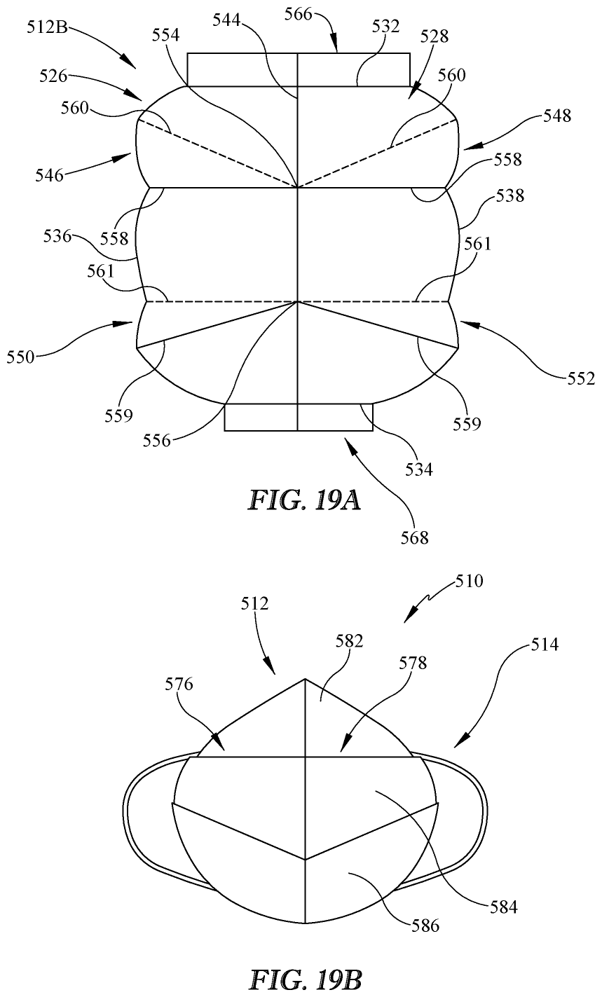

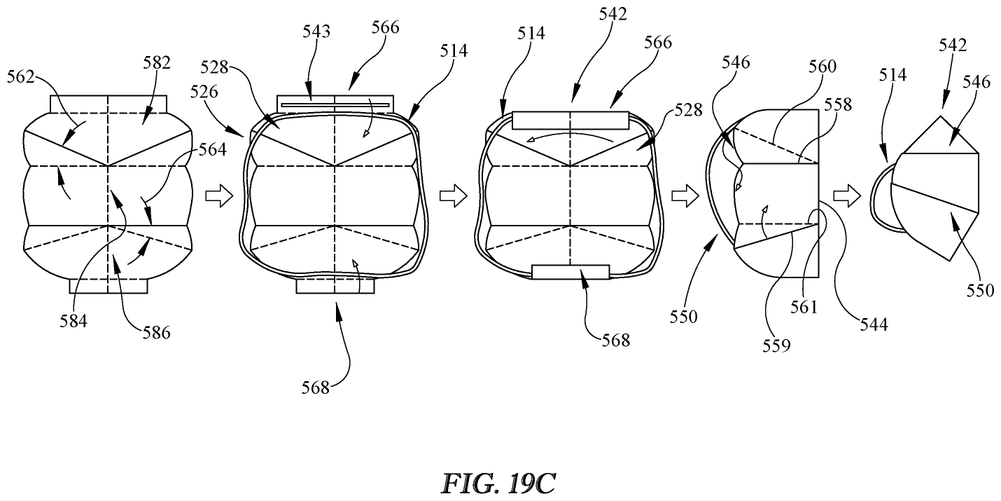

Another embodiment of a disposable face mask 510 in accordance with the present disclosure is shown in FIGS. 19A-19C. The disposable face mask 510 is substantially similar to the disposable face mask 10 shown in FIGS. 1-13 and described herein. Accordingly, similar reference numbers in the 500 series indicate features that are common between the disposable face mask 10 and the disposable face mask 510. The description of the disposable face mask 10 is incorporated by reference to apply to the disposable face mask 510, except in instances when it conflicts with the specific description and the drawings of the disposable face mask 510.

The disposable face mask 510 includes the mask body 512 and at least one attachment band 514 as shown in FIGS. 19A-19C. The attachment band 514 are coupled to the mask body 512 and configured to secure the mask body 512 on the face 13 of the user 11.

The mask body 512 includes a main portion 528, an upper attachment tab 566, and a bottom attachment tab 568 as shown in FIGS. 19A-19C. The upper tab 566 extends from an upper edge 532 of the main portion 528 and the bottom tab 568 extends form a bottom edge 534 of the main portion 528. Each of the attachment tabs 566, 568 are configured to fold over the attachment band 514 and help couple the attachment band 514 to the mask body 512.

In the illustrative embodiment, the upper attachment tab 566 is larger than the bottom attachment tab 568 as shown in FIGS. 19A-19C. The upper attachment tab 566 is larger or extend over a larger portion of the upper edge 532 of the main portion 528 such that the ear loops formed on each side 576, 578 by the attachment band 514 are in the correct position when the mask body 12 is in the folded arrangement. The position of the ear loops may be important to ensure the perimeter edge 526 of the mask body 512 contacts the face 13 of the user 11 at all points around the nose 15 and mouth 17 of the user 11.

In some embodiments, the upper and bottom attachment tabs 566, 568 are the same size. In other embodiments, the bottom attachment tab 568 may be larger than the upper attachment tab 566. In the illustrative embodiment, the size of the attachment tabs 566, 568 are adjustable to vary the fit of the disposable face mask 510 to the face 13 of the user 11.

The main portion 528 is formed to include a vertical fold line 544, first pleat folds 546, 548, and second pleat folds 550, 552 as shown in FIGS. 19A-19C. The vertical fold line 544 extends between the upper edge 532 and the bottom edge 534 of the main portion 528 at a center of the main portion 528. The first and second pleat folds 546, 548, 550, 552 are mirrored over the vertical fold line 544 of the main portion 528 and are configured to form the curvature of the mask body 512 that shapes the mask body 512 to the face 13 of the user 11 when in the mask body 512 is in the folded arrangement.

The first pleat folds 546, 548 converge at a first vertex 554, while the second pleat folds 550, 552 converge at a second vertex 556 as shown in FIGS. 19A-19C. The first vertex 554 is located on the vertical fold line 544. The second vertex 556 is located on the vertical fold line 544 vertically between the first vertex 554 and the bottom edge 534.

Each pleat fold 546, 548, 550, 552 includes a mountain fold line 558, 559 and a valley fold line 560, 561 as shown in FIGS. 19A-19C. The mountain fold lines 558, 559 extend between the corresponding vertex 554, 556 and the corresponding side edge 536, 538. The valley fold lines 560, 561 extend from the corresponding vertex 554, 556 to the corresponding side edge 536, 538. Together the mountain and valley fold lines 558, 559, 560, 561 form the pleat fold 546, 548, 550, 552 when the mask body 512 is in the folded arrangement.

In the illustrative embodiment, the mountain fold lines 558 of the first pleat folds 546, 548 and the valley fold lines 561 of the second pleat folds 550, 552 extend parallel relative to each other as shown in FIGS. 19A-19C. The valley fold lines 560 of the first pleat folds 546, 548 extend at an angle 562 relative to the corresponding mountain fold line 558. Conversely, mountain fold lines 559 of the second pleat folds 550, 552 extend at an angle 564 relative to the corresponding valley fold line 560. In the illustrative embodiment, the mountain and valley fold lines 558, 559, 560, 561 are mirrored over the vertical fold line 544 for the first and second pleat folds 548, 552 of the other side 578.

In the illustrative embodiment, the valley fold line 560 of the first pleat fold 546 extends at the angle 562 relative to the mountain fold line 558 toward the upper edge 532 of the main portion 528. Conversely, the mountain fold line 559 of the second pleat fold 550 extends at the angle 564 relative to the valley fold line 561 toward the bottom edge 534 of the main portion 528. In this way, the valley fold lines 560 and the mountain fold lines 559 extend from the corresponding vertex 554, 556 in opposite directions.

In other embodiments, the mountain and valley fold lines 558, 559, 560, 561 may be alternated in the opposite way. In such embodiments, the mountain fold line 558 of the first pleat fold 546 extends at the angle 562 relative to the valley fold line 560 toward the upper edge 532 of the main portion 528. Conversely, the valley fold line 561 of the second pleat fold 550 extends at the angle 564 relative to the mountain fold line 559 toward the bottom edge 534 of the main portion 528. In this way, the valley fold lines 561 and the mountain fold lines 558 extend from the corresponding vertex 554, 556 in opposite directions.

In the illustrative embodiment, the mask blank 512B has an upper section 582, a middle section 584, and a bottom section 586 as shown in FIGS. 19A-19C. The upper section 582 is formed between the upper edge 532 and the valley fold lines 560 of the first pleat folds 546, 548. The bottom section 586 is formed between the bottom edge 536 and the mountain fold lines 559 of the second pleat folds 550, 552. The middle section 584 is between the upper and bottom sections 582, 586 between the valley fold lines 560, 561.

Once the pleat folds 546, 548, 550, 552 are formed, the upper section 582 folds in onto itself, while the bottom section 586 folds onto a portion of the middle section 384. As such, the portion of the middle section 584 showing forms a quadrilateral shape as shown in FIGS. 19A-19C.

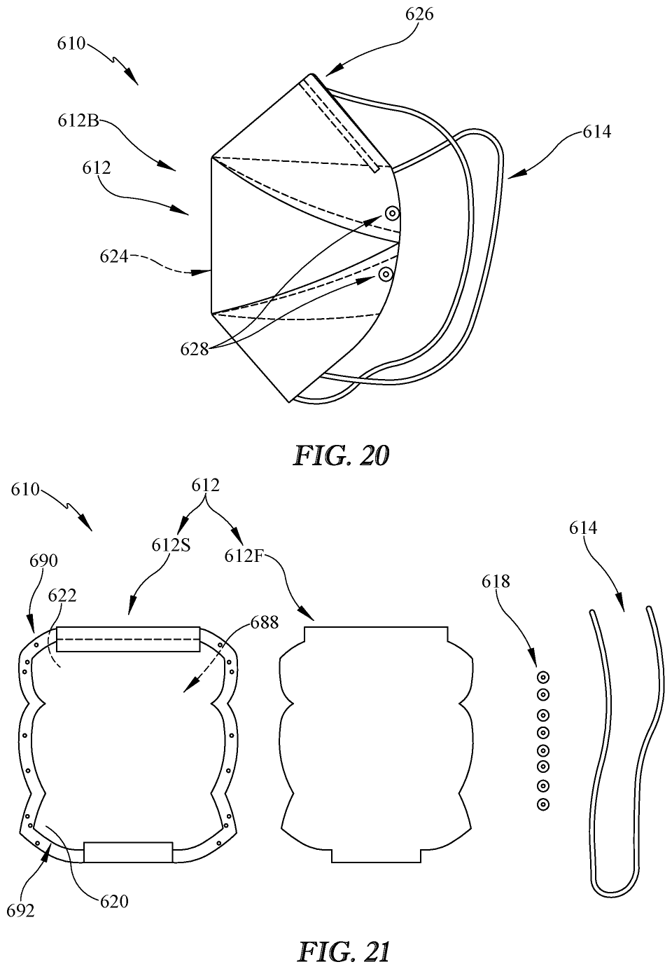

Another embodiment of a disposable face mask 610 in accordance with the present disclosure is shown in FIGS. 20-27. The disposable face mask 610 is substantially similar to the disposable face mask 10 shown in FIGS. 1-13 and the disposable face masks 310, 410, 510 shown in FIGS. 17A-19C and described herein. Accordingly, similar reference numbers in the 600 series indicate features that are common between the disposable face mask 10, 310, 410, 510 and the disposable face mask 610. The description of the disposable face mask 10, 310, 410, 510 is incorporated by reference to apply to the disposable face mask 610, except in instances when it conflicts with the specific description and the drawings of the disposable face mask 610.

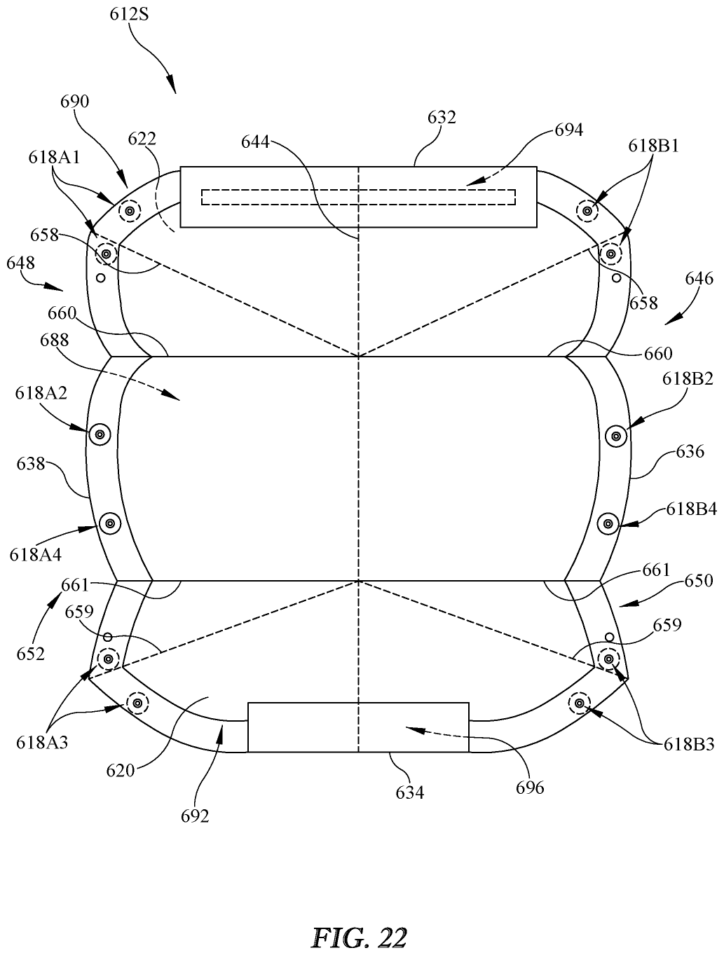

The face mask 610 includes a mask body 612, an attachment band 614 coupled to the mask body 612, and a plurality of snap buttons 618 as shown in FIGS. 21 and 22. In FIG. 21, the face mask 610 is disassembled to show the different components 612S, 612F, 614, 618 of the face mask 610. The mask body 612 comprises a mask sleeve 612S and a filter insert 612F as shown in FIGS. 21-23. The mask sleeve 612S is made of a reusable material and shaped to define a filter slot 688. The filter insert 612F is configured to be arranged in the filter slot 688 in the mask sleeve 612S so as to filter out or prevent airborne particles in the surrounding atmosphere 23 from being inhaled by the user 11.

The mask sleeve 612S and the filter insert 612F form a mask blank 612B that is configured to be folded to form the mask body 612. The mask blank 612B is configured to change between an unfolded arrangement, a folded arrangement, and a flat-folded arrangement using origami techniques as discussed above. The snap buttons 618 are configured to be selectively coupled to the mask body 612 to hold the mask body 612 together in the folded arrangement and the flat-folded arrangement. The snap buttons 618 may be selectively coupled to the mask body 612 so that the mask body 612 may be adjusted to fit the face 13 of the user 11.

In the unfolded arrangement, the mask blank 612B remains in a flat-two dimensional shape having a first surface 620, a second surface 622 opposite the first surface 620, and outer edges 632, 634, 636, 638 as shown in FIG. 22. The mask sleeve 612S forms the first surface 620, the second surfaces 622, and the outer edges 632, 634, 636, 638 in the illustrative embodiment.

In FIG. 22, the first surface 620 forms the interior side of the mask sleeve 612S. The inside of the mask sleeve 612S is the surface the user views when the mask blank 612B is unfolded and flipped interior side up into the unfolded arrangement as shown in FIGS. 21 and 22.

In the folded arrangement, the mask blank 612B is formed into a three-dimensional shape using origami techniques so that the mask body 612 forms a cavity 624 and a perimeter edge 626 as shown in FIG. 20. In the illustrative embodiment, the first surface 620 of the mask blank 612B forms a majority of the cavity 624, while the outer edges 632, 634, 636, 638 from a majority of the perimeter edge 626 when the mask body 612 is in the folded arrangement.

In the flat-folded arrangement, the mask blank 612B remains folded in three-dimensional shape of the folded arrangement with the cavity 624 collapsed so that the mask body 612 is flat. The flat-folded arrangement allows the face mask 610 to take up less space, which allows the face mask 610 to be easily packed for storage or shipping.

Then after a predetermined period of time, about 8 hours, the mask body 612 may be unfolded from the folded arrangement to the unfolded arrangement to replace the filter insert 612F. The filter insert 612F may be removed from the filter slot 688 and disposed of so that a new filter insert 612F may be arranged in the filter slot 688 of the mask sleeve 612S. In this way, the mask sleeve 612S may be reused and washed, while the filter insert 612F may be disposed of after prolonged use, like the other disposable face masks, so that the mask 10 continues to effectively filter out airborne particles in the surrounding atmosphere 23 from being inhaled by the user 11.

The mask sleeve 612S includes a first panel 690 and a second panel 692 adjacent to the first panel 690 to define the filter slot 688 as shown in FIG. 22. The second panel 692 is coupled to the first panel 690 at the upper edge 632 and the bottom edge 634 of the mask sleeve 612S. The side edges 636, 638 are free so that filter insert 612F may be inserted into the filter slot 688 between the first panel 690 and the second panel 692.

In the illustrative embodiment, the first panel 690 of the mask sleeve 612S defines the second, or outer surface 622 and the second panel 692 of the mask sleeve 612S defines the first, or inner surface 620. The filter insert 612F is located between the first and second panels 690, 692 in the filter slot 688.

In the illustrative embodiment, the filter insert 612F has the same shape or outline as the mask sleeve 612S. The filter insert 612F is sized to be the same shape and size of the second panel 692 in the illustrative embodiment. The filter insert 612F is surrounded or contained in mask sleeve 612S when the mask blank 612B is in the folded arrangement.

In the illustrative embodiment, the filter insert 612F may be any suitable material discussed above in regards to the sheet of material of the mask blank 612B. For example, the filter insert 612F may be a synthetic material, such as a melt-blown non-woven polypropylene filter, configured to filter airborne particles from being transferred between the surrounding atmosphere 23 and the user 11. In the preferred embodiments, the synthetic material is a non-woven synthetic material.

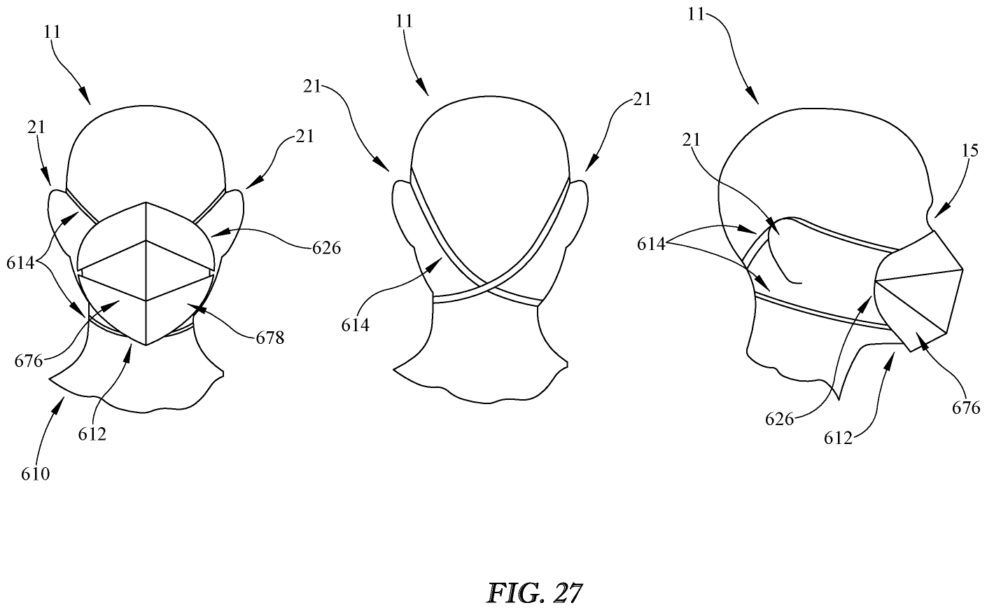

The mask sleeve 612S further includes channels 694, 696 that couple the attachment band 614 to the mask body 612. Like the attachment tabs of the other embodiments, the channels 694, 696 of the mask sleeve 612S are located on the upper edge 636 and the bottom edge 638 of the mask sleeve 612S. The attachment band 614 extends through the channels 694, 696 and is tied off to form a loop. The loop formed by the attachment band 614 may be arranged around the head of the user 11 to hold the mask body 12 in place on the face 13 of the user 11 like as shown in FIG. 27. Furthermore, the attachment band 614 can be couple with a cord adjuster thus allowing the band to be adjustable.

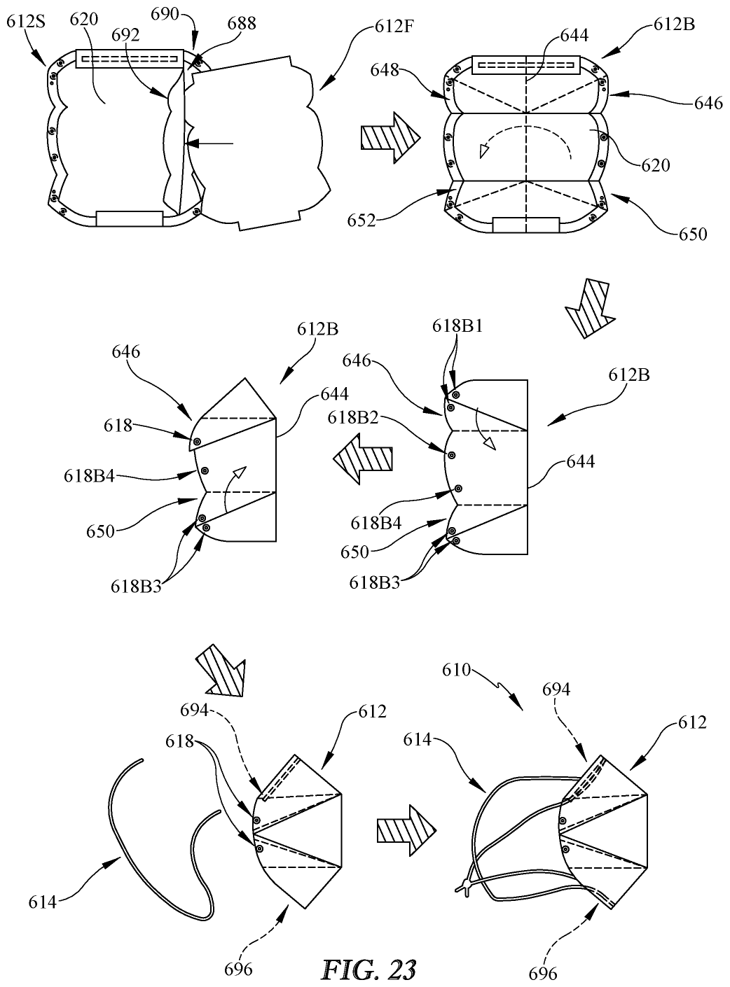

In the illustrative embodiment, each of the snap buttons 618 includes a socket portion 618A1, 618A3, 618B1, 618B3 and a corresponding stud portion 618A2, 618A4, 618B2, 618B4 as shown in FIGS. 22 and 23. Each socket portion 618A1, 618A3, 618B1, 618B3 is configured to interlock with the corresponding stud portion 618A2, 618A4, 618B2, 618B4. In the illustrative embodiment, the socket and stud portions 618A1, 618A2, 618A3, 618A4, 618B1, 618B2, 618B3, 618B4 are coupled and secured in place on the mask sleeve 612S so that the snap buttons 618 remain coupled to the mask sleeve 612S when in the unfolded arrangement.

The mask blank 612B is formed to include a vertical fold line 644, first pleat folds 646, 648, and second pleat folds 650, 652 as shown in FIGS. 22 and 23. The vertical fold line 644 extends between the upper edge 632 and the bottom edge 634 at a center of the mask blank 612B. The first and second pleat folds 646, 648, 650, 652 are mirrored over the vertical fold line 644 and are configured to form the curvature of the mask body 612 that shapes the mask body 612 to the face 13 of the user 11 when in the mask body 612 is in the folded arrangement.

The first pleat folds 646, 648 converge at a first vertex 654, while the second pleat folds 650, 652 converge at a second vertex 656 as shown in FIG. 22. The first vertex 654 is located on the vertical fold line 644. The second vertex 656 is located on the vertical fold line 644 vertically between the first vertex 654 and the bottom edge 634.

Each pleat fold 646, 648, 650, 652 includes mountain and valley fold lines 658, 659, 660, 661 as shown in FIG. 22. The fold lines 658, 659, 660, 661 extend from the corresponding vertex 654, 656 to the corresponding side edge 636, 638. The fold lines 658, 659 are angled relative to the other corresponding fold lines 660, 661. Together the mountain and valley fold lines 658, 659, 660, 661 form the corresponding pleat fold 646, 648, 650, 652 when the mask body 612 is in the folded arrangement.

In the illustrative embodiment, the fold lines 658, 659, 660, 661 of the first and second pleat folds 646, 648, 650, 652 are the same as in FIGS. 17A-17C. The fold lines 660, 661 of the first and second pleat folds 646, 648, 650, 652 extend parallel relative to each other, while each of the fold lines 658, 659 extend at the angle relative to the corresponding fold line 660, 661. In the illustrative embodiment, the fold lines 658, 659, 660, 661 are mirrored over the vertical fold line 644 for the first and second pleat folds 648, 652 of the other side 676, 678.

In other embodiments, the mask blank 612B may be folded using the method of any of the other embodiments. In some embodiments, the fold lines 658, 659, 660, 661 of the first and second pleat folds 646, 648, 650, 652 may be in the same orientation as shown in FIGS. 18A-8C. In other embodiments, the fold lines 658, 659, 660, 661 of the first and second pleat folds 646, 648, 650, 652 may be in the same orientation as shown in FIGS. 19A-19C.

The method of assembling the mask body 612 begins with inserting the disposable filter insert 612F in the filter slot 688 of the mask sleeve 612S as shown in FIG. 23. Once the filter insert 612F is in place, the mask body 612 may then be folded into the folded arrangement. With the first surface 620 of the mask blank 612B facing away from a working surface used for folding the face mask 610, the mask blank 612B is folded along the vertical fold line 644 as shown in FIG. 23. The mask blank 612B is folded along the vertical fold line 644 in such a way the first surface 620 of the mask blank 612B is folded onto itself.

To create the pleat folds 646, 648, 650, 652, the user simply secures the snap buttons 618. For example, to form the first pleat fold 646 the user secures one of the socket portions 618B1 to the stud portion 618B2 as shown in FIG. 23. This way, the pleat fold 646 may not need to be pre-pleated or pre-folded. The securing of the socket and stud portions 618B1, 618B2 automatically folds the mask blank 612B along the fold lines 658, 660.

To create the second pleat fold 650, the same process is used. The user secures one of the socket portions 618B3 to the stud portion 618B4 as shown in FIG. 23. The interlocking of the socket portion 618B3 with the stud portion 618B4 automatically folds the pleat fold 650 along the fold lines 658, 660.

In the illustrative embodiment, once the first and second pleat folds 646, 650 are formed for the first side 676 of the mask blank 612B, the steps are repeated for the first and second pleat folds 648, 652 on the other side 678 of the mask blank 612B. The first pleat fold 648 is formed by securing one of the socket portions 618A1 to the stud portion 618A2, while the second pleat fold 652 is formed by securing one of the socket portions 618A3 to the stud portion 618A4.

Each of the pleat folds 646, 648, 650, 652 may be readjusted by uncoupling the connected socket and stud portions and recoupling a different socket portion to the stud portion. The adjustment of the pleat folds 646, 648, 650, 652 is discussed in further detail below.

Once both the first and second pleat folds 646, 648, 650, 652 for each side of the mask blank 612B are formed and secured, the sides 676, 678 of the mask body 612 may be pulled away from each other to open the cavity 624. With the mask blank 612B in the three-dimensional shape, the mask body 612 is now in the folded arrangement.

The attachment band 614 may be coupled to the mask sleeve 612S before or after the mask blank 612B is folded into the folded arrangement. To couple each attachment band 614 to the mask sleeve 612S, one end of the attachment band 614 is fed through the corresponding channel 694, 696. The ends are then tied together or bundled through a cynical cord adjuster to form a loop that is configured to extend around the head of the user 11. In other embodiments, a different attachment method may be used.

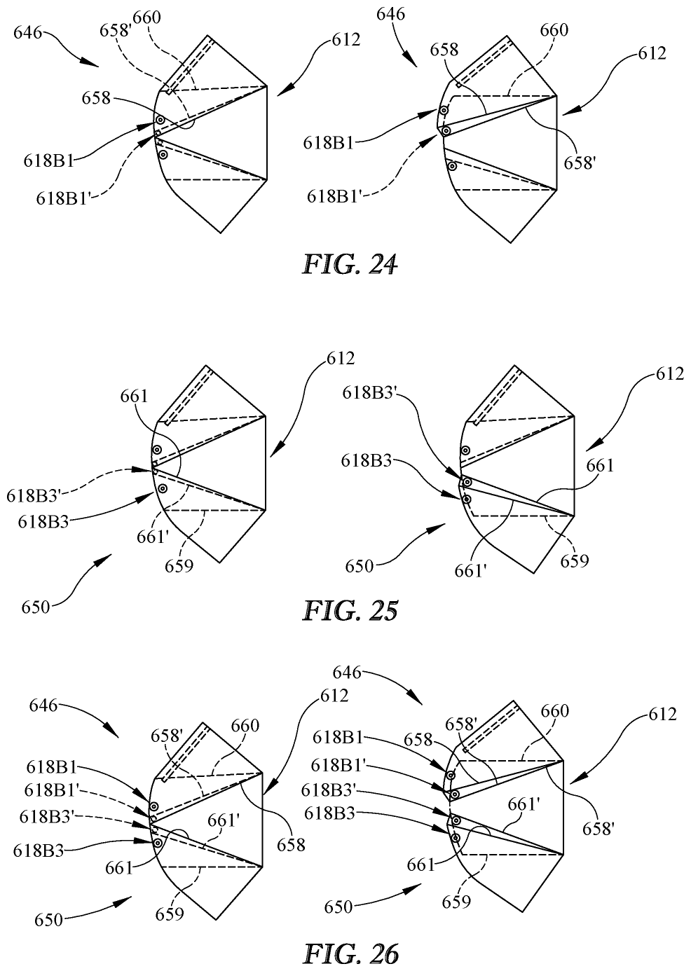

To adjust the fit of the mask body 612 to the face 13 of the user 11, the user 11, the user simply uncouples and recouples the snap buttons 618 for each of the pleat folds 646, 648, 650, 652 as shown in FIGS. 24-26. For example, for the first pleat fold 646, the user 11 disengages the socket portion 618B1 from the stud portion 618B2 as shown in FIG. 24. The user 11 then couples a different socket portion 618B1′ to the stud portion 618B2. This adjusts the pleat fold 646 along a new fold line 658′ and expands the upper portion of the mask body 612 for the user 11 as shown in FIG. 24.

The other first pleat fold 648 is adjusted in a similar manner. The user 11 disengages the engaged socket portion 618A1 from the stud portion 618A2. The pleat fold 648 is adjusted by coupling a different socket portion 618A1 to the stud portion 618A2. This adjusts the pleat fold 648 along a new fold line to expand the upper portion of the mask body 612.

To adjust the second pleat fold 650, the user 11 disengages the engaged socket portion 618B3 from the stud portion 618B4 as shown in FIG. 25. The user 11 then couples a different socket portion 618B3′ to the stud portion 618B4. This adjusts the pleat fold 650 along a new fold line 661′ and expands the lower portion of the mask body 612 for the user 11 as shown in FIG. 25.

The other second pleat fold 652 is adjusted in a similar manner. The user 11 disengages the engaged socket portion 618A3 from the stud portion 618A4. The pleat fold 652 is adjusted by coupling a different socket portion 618A3 to the stud portion 618A4. This adjusts the pleat fold 652 along a new fold line to expand the upper portion of the mask body 612.

The first and second pleat folds 646, 648, 650, 652 may be individually adjusted or adjusted together as shown in FIGS. 24-26. Both first and second pleat folds 646, 648, 650, 652 may be adjusted as shown in FIG. 26. The first pleat fold 646 is adjusted to expand the upper portion of the face mask 610, while the second pleat fold 650 is adjusted to expand the lower portion of the face mask 610. The same may be done for the other pleat folds 648, 652 on the other side 678 of the mask 619.

The adjusted mask 610 should fitted so that perimeter edge 626 contacts the face 13 of the user 11 around all points around the nose 15 and mouth 17 of the user 11 to form a seal therebetween. If the perimeter edge 626 does not contact the face 13 of the user 11 in all the necessary areas, the different components of the mask body 612 should be adjusted as discussed above to ensure a good fit for the user 11.

With the fit adjusted to the user 11, the face mask 610 may then be worn by the user 11 by arranging the nose 15 and mouth 17 of the user 11 in the cavity 624 so that the perimeter edge 626 extends around the nose 15, mouth 17, and chin 19 of the user 11. The attachment band 614 is then arranged over the ears 21 of the user 11 to bring the perimeter edge 626 of the mask body 12 into contact with the face 13 of the user 11 and secure the mask body 12 to the face 13 of the user 11. The attachment band 614 can then be further adjusted to so the mask body 12 can be contacted with the face 13 of the user 11 with no gap.

In the illustrative embodiment, the attachment band 614 crisscrosses around the neck of the user 11 as shown in FIG. 27. The attachment band 614 wraps over the ears 21 and around the neck for a more comfortable fit. In this arrangement, the attachment band 614 does not rest heavily on the ears 21 of the user 11.

The present disclosure teaches a face mask 10 that covers the face 13 of a wearer 11, including the nose 15, mouth 17, and chin 19. The origami techniques used to fold the mask body 12 of the face mask 10 provides an adjustable tight-fit for the wearer's face 13. The mask body 12 is folded from a single sheet of material and can be flat packed or flat-folded when not being used. The mask body 12 of the face mask 10 is three-dimensional and the folds 46, 48, 50, 52 can be adjusted to fit the face 13 of the wearer 11 tightly.

The face mask 10 is adapted to be used as a face mask that can be used in cleanrooms, medical facilities, and so forth by healthcare workers. The face mask 10 may also be used as a personal protective device for use by the general public during a virus pandemic. In some embodiments, the face mask 10 is disposable.

The mask body 12 of the face mask 10 is based on an origami technique and uses two pleats of folds 46, 48, 50, 52 on either side of the mask 10. The mask body 12 is folded from a single sheet of material (i.e. the un-folded arrangement) to the three-dimensional shape (i.e. the folded arrangement). The pleats folds 46, 48, 50, 52 can be adjusted to fit the face 13 tightly.

In some embodiments, the upper attachment tab 266 forming the nose bridge 242 may be the same size as the bottom attachment tab 268. In other embodiments, the size of the attachment tabs 366, 368, 466, 468, 566, 568 may be adjustable.

In the illustrative embodiment, a piece of metal wire 43 is added at the nose bridge 42 and two pieces of elastic cords 14, 16 are added to the mask body 12 in order to facilitate the tight fit. The material may be a composite that is a combination of polymer-based melt blown and spun-bond that can filter out airborne pathogens such as the COVID-19 virus.

The sheet of material has the quality of both fabric and paper, which allows the mask body 12 to be change from the unfolded arrangement to the folded arrangement using origami techniques to form and maintain the three-dimensional shape. The fabric paper composite can be both moisture-absorptive and breathable.

Since current surgical masks are mainly designed to prevent contaminants passing from a medical professional to a patient during a surgery, such common surgical masks do not provide a good fit to the face 13 of the wearer. In order to prevent contamination and infection of health care professionals by airborne pathogens, such as the COVID-19 virus, medical professionals are required to wear respirators, such as medical N95 respirators.

The medical N95 respirators can block out 95 percent of airborne particles. However, medical N95 masks are very expensive and may not be comfortable to wear for more than a few hours. During the 2020 COVID-19 virus pandemic, surgical masks have been used by both medical providers and by millions of people in the general public. Therefore, there is a need to redesign the surgical mask so that it can provide a good fit for the user's face 13 and in doing so become more efficient at filtering out airborne pathogens such as the COVID-19 virus. This invention is therefore intended to be used like a surgical mask, yet provides a tight fitting for the face 13.

The invention is packed in a two-dimensional shape (i.e. the flat-folded arrangement) and is configured to be deployed into a three-dimensional form (i.e. the folded arrangement) to fit the face 13. The pleat folds 46, 48, 50, 52 may be connected using removable mechanisms or mechanical fasteners.

For a tight fit, a wearer 11 can remove the mechanisms and adjust the pleat folds 46, 48, 50, 52. Once the pleat folds 46, 48, 50, 52 are adjusted to fit the face 13 of the wearer 11, the pleat folds 46, 48, 50, 52 may be re-secured using the same removable mechanisms.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A face mask adapted for covering a nose and mouth of a user to form a barrier between the nose and mouth of the user and the surrounding atmosphere, the mask comprising
a mask body formed from a mask blank made of a two-dimensional mask blank and configured to change between an unfolded arrangement in which that the mask blank is in a two-dimensional shape, a folded arrangement in which the mask blank is formed into a three-dimensional shape using origami techniques so that the mask body forms an cavity sized to receive the nose and mouth of the user and a perimeter edge that contacts a face of the user around the nose and mouth so that the mask body is spaced apart from the nose and mouth of the user, and a flat-folded arrangement in which the mask blank remains folded and the cavity is collapsed so that the mask body is substantially flat so as to allow the mask body to be stacked by packaging, and
at least one attachment band coupled to the mask body and configured to extend between mask body and the user to secure the mask body in the folded arrangement on the face of the user so that the perimeter edge contacts the face of the user when the user is using the face mask, wherein the three dimensional shape of the mask body in the folded arrangement is configured to be adjustable to fit the face of the user.

2. The mask of claim 1, wherein the mask body includes a vertical fold line that extends vertically along a center of the mask blank between an upper edge and a bottom edge of the mask blank spaced apart from the upper edge, first pleat folds that extend from a first vertex located on the vertical fold line to corresponding side edges of the main portion that extend between and interconnect the upper and bottom edges, and second pleat folds that extend from a second vertex located on the vertical fold line vertically between the first vertex and the upper edge of the mask blank to the corresponding side edges of the mask blank, and wherein the arrangements of the first and second pleat folds are adjustable to vary a size of the perimeter edge of the mask body when the mask body is in the folded arrangement.

3. The mask of claim 2, wherein the location of at least one of the first vertex and the second vertex is adjustable along the vertical fold line to vary the size of the perimeter edge of the mask body when the mask body is in the folded arrangement.

4. The mask of claim 2, wherein each of the first and second pleat fold lines include a mountain fold line that extends from the corresponding vertex to the corresponding side edge and a valley fold line that extends from the corresponding vertex to the corresponding side edge at an angle relative to the mountain valley fold line.

5. The mask of claim 4, wherein the angle between the mountain fold line and the valley fold line is adjustable to vary a size of the perimeter edge of the mask body when the mask body is in the folded arrangement

6. The mask of claim 1, the sheet of material forming the mask blank is a synthetic material configured to filter particles from being transferred between the surrounding atmosphere and the user.

7. The mask of claim 6, wherein the synthetic material is one of non-woven synthetic material, woven synthetic material, and polyethylene.

8. The mask of claim 1, wherein the sheet of material forming the mask blank is water resistant.

9. The mask of claim 1, wherein the sheet of material forming the mask blank is a composite material having at least one layer of material.

10. The mask of claim 1, wherein the mask blank comprises a mask sleeve having a first panel and a second panel coupled to the first panel and located adjacent to the first panel to define a filter slot therebetween and a disposable filter insert arranged in the slot between the first panel and the second panel of the mask sleeve.

11. The mask of claim 10, wherein the mask body includes a vertical fold line that extends vertically along a center of the mask blank between an upper edge and a bottom edge of the mask blank spaced apart from the upper edge, first pleat folds that extend from a first vertex located on the vertical fold line to corresponding side edges of the main portion that extend between and interconnect the upper and bottom edges, and second pleat folds that extend from a second vertex located on the vertical fold line vertically between the first vertex and the upper edge of the mask blank to the corresponding side edges of the mask blank, and wherein the arrangements of the first and second pleat folds are adjustable to vary a size of the perimeter edge of the mask body when the mask body is in the folded arrangement.

12. The mask of claim 11, further comprising a plurality of snap buttons configured to selectively couple to the first pleat folds and the second pleat folds to block the first and second pleat folds from unfolding and secure the mask in the folded arrangement and flat-folded arrangement.

13. The mask of claim 12, wherein the location of at least one of the first vertex and the second vertex is adjustable along the vertical fold line to vary the size of the perimeter edge of the mask body when the mask body is in the folded arrangement, and wherein the plurality of snap buttons are configured to be adjustable.

14. A method of forming a face mask using origami techniques to form a three-dimensional shape from a two-dimensional sheet of material, the method comprising
providing a mask blank made of the sheet of material having a first surface and a second surface opposite the first surface, the mask blank including vertical fold line that extends vertically along a center of the mask blank between an upper edge and a bottom edge of the mask blank spaced apart from the upper edge, first pleat folds that extend from a first vertex located on the vertical fold line to corresponding side edges of the main portion that extend between and interconnect the upper and bottom edges, and second pleat folds that extend from a second vertex located on the vertical fold line vertically between the first vertex and the upper edge of the mask blank to the corresponding side edges of the mask blank,
folding the mask blank along the vertical fold line to form the sides of the face mask,
folding the first pleat fold and the second pleat fold on a first side of the mask by folding along corresponding mountain and valley fold lines to form a portion of a curvature shape of the face mask,
folding the first pleat fold and the second pleat fold on a second side of the mask by folding along corresponding mountain and valley fold lines to form another portion of a curvature shape of the face mask,
coupling at least one elastic attachment band to the face mask,
checking a fit of the face mask on a face of a user, and
adjusting the first and second pleat folds on at least one of the first side and the second side of the mask to fit the face of the user such that a perimeter edge of the face mask contacts the face of the user along the entire perimeter edge.

15. The method of claim 14, further comprising moving a location of at least one of the first vertex and the second vertex along the vertical fold line to vary the size of the perimeter edge of the face mask.

16. The method of claim 14, further comprising adjusting an angle between the mountain fold line and the valley fold line of at least one of the first and second pleat folds to vary a size of the perimeter edge of the face mask.

17. The method of claim 14, wherein the mask blank comprises a mask sleeve having a first panel and a second panel coupled to the first panel and located adjacent to the first panel to define a filter slot therebetween and a disposable filter insert configured to be fit in the slot between the first panel and the second panel of the mask sleeve, the first panel defines the first surface of the mask blank, and the second panel defines the second surface of the mask blank, and
wherein the method further comprises inserting the disposable filter insert in the filter slot between the first panel and the second panel before folding the mask blank along the vertical fold line.

18. The method of claim 17, further comprising a plurality of snap buttons, wherein the method further comprises coupling a first snap button to the first pleat fold and coupling a second snap button to the second pleat fold on the first side of the mask after folding the first and second pleat folds on the first side of the mask to block the first and second pleat folds on the first side of the mask from unfolding and coupling a third snap button to the first pleat fold and coupling a fourth snap button to the second pleat fold on the second side of the mask after folding the first and second pleat folds on the second side of the mask to block the first and second pleat folds on the second side of the mask from unfolding.

19. The method of claim 18, further comprising uncoupling the first, second, third, and fourth snap buttons before adjusting the first and second pleat folds on at least one of the first side and the second side of the mask.

20. The method of claim 14, further comprising coupling a first elastic attachment band to the first side of the face mask and coupling a second elastic attachment band to the second side of the face mask.
